(19) United States
(12) Patent Application Publication
(10) Pub. No.: US 2020/0352106 A1
(43) Pub. Date: Nov. 12, 2020

(54) Compositions and Methods for Enhanced CO2 Capture and Storage

(71) Applicant: CO2 Solved, LLC, Junction City, OR (US)

(72) Inventors: George Baker, Junction City, OR (US); Sheryl S. Webb, Creswell, OR (US); Clifford Fairchild, Corvallis, OR (US); Timothy A. Baker, Junction City, OR (US)

(73) Assignee: CO2 Solved, LLC, Junction City, OR (US)

(21) Appl. No.: 16/861,085

(22) Filed: Apr. 28, 2020

Related U.S. Application Data
(60) Provisional application No. 62/841,638, filed on May 1, 2019.

(51) Int. Cl. A01G 7/06; A01N 59/06; A01N 59/16; A01N 25/30; A01N 25/04; A01G 15/00

(52) U.S. Cl. CPC A01G 7/06; A01N 59/06; A01N 59/16; B82Y 30/00; A01N 25/04; A01G 15/00; A01N 25/30

(57) ABSTRACT

Provided are compositions and methods for reducing foliar chloroplast movement in plants and trees to enhance CO₂ trapping (carbon capture) from the air while naturally increasing the oxygen in the atmosphere and diluting the concentration of greenhouse gasses. Also provided are methods for measuring foliar chloroplast avoidance in response to treatments designed to reduce avoidance. Also provided are compositions and methods for reducing bud temperature increases during the dormancy phase of deciduous plants and trees, and compositions and methods for increasing winter chill accumulation in deciduous plants and trees.

### CROSS-REFERENCE TO RELATED APPLICATION

This application claims the benefit of U.S. Application No. 62/841,638, filed May 1, 2019, expressly incorporated herein by reference in its entirety.

### FIELD OF THE DISCLOSURE

The disclosure provides a new approach to enhancing CO₂ trapping (carbon capture) from the air while naturally increasing the oxygen in the atmosphere and diluting the concentration of greenhouse gasses.

### BACKGROUND OF THE DISCLOSURE

Global warming due to the atmospheric CO₂ has received international attention. The Paris Agreement (Accord de Paris), Paris climate accord or Paris climate agreement, is an agreement within the United Nations Framework Convention on Climate Change (UNFCCC) dealing with greenhouse gas emissions mitigation, adaptation and finance in the year 2020. One of the aims of the agreement is to increase the ability to adapt to the adverse impacts of climate change and foster climate resilience and low greenhouse gas emissions development, in a manner that does not threaten food production.

Approaches to this aim have not to date fulfilled these needs. Plants themselves offer potential for chloroplast processing of excess atmospheric CO₂. Chloroplast movement in leaves allows plants to dynamically adapt to optimize use of the available solar energy while minimizing harm from overexposure to light. However, from the perspective of using plants commercially to reduce atmospheric CO₂, the chloroplast avoidance motion is not optimal for CO₂ capture and therefore photosynthesis.

The compositions and methods of the present disclosure provide a solution to this disadvantage, by reducing and preventing the chloroplasts' daytime avoidance of light. The disclosure also provides for determining the effectiveness of methods designed to optimize photosynthesis in plants, for example by reducing foliar avoidance movement by chloroplasts.

### SUMMARY OF THE DISCLOSURE

Provided is a method for reducing light-sensitive foliar chloroplast movement in a plant leaf comprising applying to a surface of the leaf a treatment comprising titanium dioxide and calcium carbonate, wherein the treatment further comprises at least one surfactant. The titanium dioxide can have a particle size of about 10 nm-about 500 nm, and the calcium carbonate can have a particle size of about 200 nm to about 3 microns.

In the method the surfactant can be selected from the group consisting of lecithin, ether carboxylate, alkyl ethoxylate, and silicone.

In one embodiment of the method, the treatment is formulated with wet ground calcium carbonate and comprises components selected from the following ranges: Potable water, 8.85-20.85 w/w %; Esperse 366, 0.5-1 w/w %; Titanium dioxide, 0.5-5.0 w/w %; CCCWG at 74% Calcium Carbonate, 78-84 w/w %; Silicone PMX200, 0.1-0.5 w/w %; Mergal K10ON, 0-0.25 w/w %; Mergal 186, 0-0.25 w/w %; and Guar Gum, 0.05-0.15 w/w %.

In another embodiment of the method, the treatment is formulated with dry ground calcium carbonate and comprises components selected from the following ranges: Potable water, 25.65-74.35 w/w %; Dispersogen PCE, 0.5-1.0 w/w %; Soy Lecithin, 2.0-3.0 w/w %; Sodium carbonate: 0.2-0.5 w/w %; CCCDG, 58-61.5 w/w %; Alcohol 1.5-3.0 w/w % (ethanol or isopropanol); Clove Oil, 0-0.2 w/w %; Guar Gum 0.05-0.15 w/w %; and Titanium dioxide, 0.5-5 w/w %.

In some embodiments the titanium dioxide ranges in size from 10 nm to 50 nm, such as 10 nm, and used at a concentration of 50 ppm-500 ppm, such as 300 ppm. The titanium dioxide can also be used at sizes of 200-250 nm as a blend, and at a concentration of 1% to 5% by weight. These percentages are not intended to exclude additional concentrations that still accomplish the results as contemplated herein. For example a concentration of between 5% and 6%, or above, is also within the scope of the disclosure.

Further provided is a composition of matter formulated with dry ground calcium carbonate, the composition comprising Potable water, 30.08% w/w %; Dispersogen PCE, 0.95% w/w %; Soy Lecithin, 2.71 w/w %; Sodium carbonate, 0.38 w/w %, CCCDG, 58.43 w/w %; Alcohol, 2.14 w/w % (ethanol or isopropanol); Clove Oil, 0.19 w/w %; Guar Gum, 0.12 w/w %; and Titanium dioxide, 5.00 w/w %, and a composition of matter formulated with wet ground calcium carbonate, the composition comprising Potable water, 14.44 w/w %; Esperse 366, 1.00 w/w %; Titanium dioxide, 5.00 w/w %; CCCWG at 74% Calcium Carbonate, 78.96 w/w %; Silicone PMX200, 0.25 w/w %; Mergal K10N, 0.15 w/w %; Mergal 186, 0.10 w/w %; and Guar Gum, 0.10 w/w %.

Also provided is a method of enhancing chlorophyll production in a conifer and other agricultural plants, comprising applying to a surface of the conifer a treatment comprising titanium dioxide and calcium carbonate, wherein the treatment further comprises a surfactant. The titanium dioxide can have a particle size of about 10 nm to about 500 nm, and the calcium carbonate can have a particle size of about 200 nm to about 3 microns. In the method, the surfactant can be selected from the group consisting of lecithin (abbreviated lec.), ether carboxylate, alkyl ethoxylate, and silicone.

In the method of enhancing chlorophyll production in a conifer and other agricultural plants, the treatment can be selected from the group consisting of:

(a) a composition comprising components selected from the following ranges: Potable water, 8.85-20.85 w/w %; Esperse 366, 0.5-1 w/w %; Titanium dioxide, 0.5-5.0 w/w %; CCCWG at 74% Calcium Carbonate, 78-84 w/w %; Silicone PMX200, 0.1-0.5 w/w %; Mergal K10N, 0-0.25 w/w %; Mergal 186, 0-0.25 w/w %; and Guar Gum, 0.05-0.15 w/w %; and

(b) a composition comprising components selected from the following ranges: Potable water, 25.65-74.35 w/w %; Dispersogen PCE, 0.5-1.0 w/w %; Soy Lecithin, 2.0-3.0 w/w %; Sodium carbonate 0.2-0.5 w/w %; CCCDG, 58-61.5 w/w %; Alcohol 1.5-3.0 w/w % (ethanol or isopropanol); Clove Oil, 0-0.2 w/w %; Guar Gum 0.05-0.15 w/w %; and Titanium dioxide, 0.5-5 w/w %.

Further provided is method for measuring the effect of a treatment on the rate of foliar chloroplast movement in a plant leaf, the method comprising: exposing a treated half and untreated half of the plant leaf (samples of the same leaf) to linear polarized laser light of 405 nm wavelength; measuring transmission of light by the treated and untreated samples; and comparing the light transmission by the treated and untreated samples, wherein reduced transmission in the treated samples indicates that the treatment is effective to reduce the rate of the foliar chloroplast movement.

In the method for measuring the effect of a treatment on the rate of foliar chloroplast movement in a plant leaf, the treatment can comprise application to the surface of the leaf a composition selected from the group consisting of:

(a) a composition comprising components selected from the following ranges: Potable water, 8.85-20.85 w/w %; Esperse 366, 0.5-1 w/w %; Titanium dioxide, 0.5-5.0 w/w %; CCCWG at 74% Calcium Carbonate, 78-84 w/w %; Silicone PMX200, 0.1-0.5 w/w %; Mergal K10N, 0-0.25 w/w %; Mergal 186, 0-0.25 w/w %; and Guar Gum, 0.05-0.15 w/w %; and

(b) a composition comprising components selected from the following ranges: Potable water, 25.65-74.35 w/w %; Dispersogen PCE, 0.5-1.0 w/w %; Soy Lecithin, 2.0-3.0 w/w %; Sodium carbonate, 0.2-0.5 w/w %; CCCDG, 58-61.5 w/w %; Alcohol 1.5-3.0 w/w % (ethanol or isopropanol); Clove Oil, 0-0.2 w/w %; Guar Gum 0.05-0.15 w/w %; and Titanium dioxide, 0.5-5 w/w %.

In the method for measuring the effect of a treatment on the rate of foliar chloroplast movement in a plant leaf, the treated and untreated samples are preferably obtained from the same leaf. Thickness and chlorophyll content and/or chloroplast distribution can be inconsistent from leaf to leaf.

More consistent data can be achieved when the exact same area of a given leaf is exposed to the 405 nm laser beam twice, first as a bare leaf, followed by leaf treatment, and then a second exposure to the laser beam. Optionally, a lower power laser can be used, specifically a lower power 405 nm diode laser. With the lower power laser, beamsplitting to reduce laser power is not needed.

Further provided is a method that allows the same chlorophyll in the same leaf areas to avoid chlorophyll and chloroplast distribution in the same leaf, by exposure and measurement first as a bare leaf, followed by leaf treatment, and then a second exposure to the laser beam followed by measurement.

Also provided is method of evaluating the effectiveness of a composition as a sunscreen, the method comprising applying the composition to a plant leaf and measuring the ability of the composition to reduce light-induced chloroplast movement.

Further provided is a method of improving water use efficiency in plants and evaluating the improvement, the method comprising applying the composition to a plant leaf and measuring the ability of the treatment to decrease water use.

Also provided is a method of enhancing chilling in tree, vine, and shrub crops (including fruits, berries and nuts) by applying a composition of the disclosure to the tree, vine or shrub, thereby promoting dormancy.

Further provided is a method of protecting fruit tree buds, including walnut, cherry and pomegranate, from increased temperature during the winter months, the method comprising treating the trees with one or more applications of the CaCO₃/TiO₂ formulation CCCWGFW-T.

Also provided is a method for reducing bud temperature increases during dormancy of a deciduous plant, the method comprising treating the plant with a composition comprising nanoparticles of titanium dioxide, nanoparticles of calcium carbonate, at least one surfactant, and water in an amount adequate to provide flowability.

The treatment can be formulated with wet ground calcium carbonate and comprising components selected from the following ranges: Potable water, 8.85-20.85 w/w %; Esperse 366, 0.5-1 w/w %; Titanium dioxide, 0.5-5.0 w/w %; CCCWG at 74% Calcium Carbonate, 78-84 w/w %; Silicone PMX200, 0.1-0.5 w/w %; Mergal K10N, 0-0.25 w/w %; Mergal 186, 0-0.25 w/w %; and Guar Gum, 0.05-0.15 w/w %.

The plant can be selected from the group consisting of but not limited to almond, apricot, cherry, grape, pear, peach, nectarine, pistachio, plum, walnut, apple, blackberry, blueberry, chestnut, currant, fig, filbert, gooseberry, kiwi, mulberry, persimmon, plum cot, pomegranate, quince, strawberry, and raspberry.

The treatment can cover at least 40%, at least 50%, or at least 60% of the plant trunk, stem, branch and bud area; the treatment can be applied at least once prior to endodormancy.

The treatment can be applied at least once after endodormancy and prior to bud break, and the treatment is applied two, three, or four times after endodormancy and prior to bud break.

Further provided is a method of increasing winter chill accumulation in a deciduous plant, the method comprising treating the plant with a composition comprising nanoparticles of titanium dioxide, nanoparticles of calcium carbonate, at least one surfactant, and water in an amount adequate to provide flowability.

The treatment can be formulated with wet ground calcium carbonate and comprises components selected from the following ranges: Potable water, 8.85-20.85 w/w %; Esperse 366, 0.5-1 w/w %; Titanium dioxide, 0.5-5.0 w/w %; CCCWG at 74% Calcium Carbonate, 78-84 w/w %; Silicone PMX200, 0.1-0.5 w/w %; Mergal K10N, 0-0.25 w/w %; Mergal 186, 0-0.25 w/w %; and Guar Gum, 0.05-0.15 w/w %.

The plant can selected from the group consisting of but not limited to almond, apricot, cherry, grape, pear, peach, nectarine, pistachio, plum, walnut, apple, blackberry, blueberry, chestnut, currant, fig, filbert, gooseberry, kiwi, mulberry, persimmon, plum cot, pomegranate, quince, strawberry, and raspberry.

The treatment can cover at least 40%, at least 50%, or at least 60% of the plant trunk, stem, branch and bud area, and can be applied at least once prior to endodormancy.

The treatment can be applied at least once after endodormancy and prior to bud break; the treatment can be applied two, three, or four times after endodormancy and prior to bud break.

### BRIEF DESCRIPTION OF THE DRAWINGS

FIG. 1 shows the steps of photosynthesis in schematic form.

FIG. 2. FIG. 2A shows a schematic diagram of apparatus for measuring the variation in light transmission of a mounted leaf as a function of time.

FIG. 2B shows a schematic diagram of apparatus for a second method of measuring the variation in light transmission of a mounted leaf, wherein measurements are taken from the same leaf that is untreated, then treated with a composition of the disclosure.

FIGS. 3A-C show foliar chloroplast movement in Nasturtium leaves. FIG. 3A shows a bare leaf without light exposure. FIG. 3B shows chloroplast response of a bare untreated leaf following exposure to 405 nm diode laser light. FIG. 3C shows chloroplast response of a leaf treated with CCCDGF-TD as defined in the Detailed Description following exposure to 405 nm diode laser light.

FIG. 4 is a temporal scan of 405 nm diode laser power transmitted through the treated half of the Oxalis leaf used for the experiment shown in FIG. 5. The leaf treatment consisted of CCCDGF-TD. Treatments are as defined in the Detailed Description.

FIG. 5 is a temporal scan of 405 nm diode laser power transmitted through a thin untreated Oxalis leaf.

FIG. 6 shows chloroplast movement reduction factor (RF) for treated Oxalis leaves using 405 nm diode laser light. The leaf treatments consisted of titanium dioxide preparations at 5% w/w in 4 gal/100 water and NSS45. Treatments are as defined in the Detailed Description.

FIG. 7 shows chloroplast movement reduction factor (RF) for treated Nasturtium leaves using 405 nm diode laser light. The leaf treatments are CCCDGFW-TD, E, F, G. Treatments are as defined in the Detailed Description.

FIG. 8 shows chloroplast migration (in microns) in two different Nasturtium leaves pre- and post-treatment using the formula CCCDGFW-TD as defined in the Detailed Description.

FIG. 9 shows chloroplast movement reduction factor in a ladder study of percent TD in CCCDGF on Oxalis leaves.

FIG. 10 shows temporal variation of transmission of a 405 nm laser beam through a single peppermint leaf. Upper scan (circles): bare leaf. Lower scan (squares): treated leaf (CRC058 (CaCO₃) w/3395 (200 nm TiO₂) (5% solution)).

FIG. 11 shows temporal variation of transmission of 405 nm laser beam through a peppermint leaf. Upper scan: bare leaf. Lower scan: leaf treated with CRC058 w/3395 (150 nm TiO₂) (5% solution)+150 ppm 10 nm TiO₂.

FIG. 12 shows temporal variation of transmission of 405 nm laser beam through a peppermint leaf. upper scan: bare leaf. lower scan: treated leaf (CRC058 w/RDI-S(5%)+300 ppm 5, 10, 20 nm TiO₂ nanoparticles).

FIG. 13 is a graph illustrating plant growth potential at varying temperatures.

FIG. 14 is a graph illustrating the temperatures recorded at 4-minute intervals in untreated azalea buds and azalea buds on trees treated with 8% calcium. Ambient air temperature was also recorded.

FIG. 15 is a graph illustrating the temperatures recorded at 2-minute intervals in untreated azalea buds and azalea buds on trees treated with 4% calcium. Ambient air temperature was also recorded.

### DETAILED DESCRIPTION

The potential for plants including trees to mitigate the increasing carbon dioxide in the Earth's atmosphere is well known and is exemplified by evidence from diverse locations in the world. One of many examples involves a single tree, and the other an entire country. The General Sherman Giant Sequoia is located in Sequoia National Park in California. At 275 feet (83 meters) tall, it is recognized as the world's tallest tree. By one calculation, this single tree has stored over a full human lifetime of carbon dioxide emission. (www.dewharvest.com/carbon-dioxide-stored-by-general-sherman-giant-sequoia.html)

At the other end of the spectrum, evidence from the Himalayan country Bhutan demonstrates that by preserving forest and agriculture, a country can achieve balance with carbon dioxide production. Bhutan is carbon negative, removing more greenhouse gasses from the atmosphere than it emits. (www.cnn.com/2018/10/11/asia/bhutan-carbon-negative/index.html)

It is not practical to solve the problem of greenhouse gas emissions by using individual trees like giant sequoias, or by returning the industrialized world to an agrarian pre-industrial existence, with wide areas of land once again covered by forest and farmland. Instead, society on a global scale needs new ways to utilize existing plant and forest growth, as well as new growth, to remove carbon dioxide from the air.

The present disclosure adds to and improves on existing approaches to carbon capture and reducing greenhouses gases in several ways. First, the disclosure provides new methods and materials for measuring and documenting chloroplast light-avoidance reduction in plants with and without treatments such as but not limited to those disclosed herein, which comprise calcium carbonate and titanium dioxide. Light-avoidance movement slows and/or stops photosynthesis (Wada, M. et al., Methods in Molecular Biology 774:87-102, 2011)

As noted above, one of the aims of the Paris Agreement is to increase the ability to adapt to the adverse impacts of climate change in a manner that does not threaten food production. This aim is also relevant to production of fiber in crops such as cotton. The methods and compositions disclosed herein can allow the production of more food and fiber even under conditions of climate change.

As used herein, plant “leaf” includes needles such as those of conifers, and “plant” is used in the broad definition to include plants occurring in the wild, landscape plants, garden plants, agricultural plants, and trees, including but not limited to horticultural trees such as fruit trees and nut crop trees. “Foliar” is used in the art-accepted definition to mean relating to leaves. The methods detect and interpret the reduced rotation of chlorophyll chromophore transition dipole moments toward alignment with the direction of polarization of laser light. The third method described herein measures the rate of strong light chloroplast avoidance movement inside plant leaf cells.

Secondly, the disclosure is directed to physical application of a composition comprising titanium dioxide and calcium carbonate in a flowable agricultural formula to plant leaf surfaces to increase chlorophyll production in a plant. “Flowable agricultural formula” is used in the art-recognized meaning to describe a suspended concentrate of ingredients. Optionally, the composition comprising dry calcium carbonate, titanium dioxide and surfactant can be made flowable at or near the site of application with the addition of water. Further details of the composition preparation are disclosed herein. The increased chlorophyll results in increased capture and sequestration of carbon molecules from the atmosphere. A further beneficial result is the increased release of oxygen occurring when the plant manufactures chlorophyll. A suitable but non-limiting application method is by spraying.

Thirdly, the methods and compositions disclosed have the capacity to be scaled up to effect large-scale increases in photosynthesis by existing plants both private and public, range lands, fields and forests, and thereby achieve a globally meaningful reduction in atmospheric CO₂.

In the present disclosure, when the term “carbon capture” by one or more plants (including trees and crops) is used it refers to “carbon capture, utilization and storage” by the plant.

Chlorophyll Presence in Stems, Twigs and Buds.

Leaves are the main plant organs which contain the majority of chlorophyll and are optimized for photosynthesis; however, active chloroplasts abound in other plant organs including stems, twigs, buds, flowers and fruit of woody plants. (Aschan, A. et al., Flora 198:81-97, 2003) The photosynthesis of these other organs offset their own carbon demand, improving the overall energy balance of woody plants. (Pfanz, H. et al., Progress in Botany, 62:477-510, 2001)

It is not always apparent that stems and twigs contain chlorophyll; if the outer bark, composed of mostly dead cells and the periderm layer underneath, is scraped off, green tissues of the cortex are revealed. These are assimilating tissues containing chlorophyll called chlorenchyma. On surface area basis, leaves normally have 2-3 times higher chlorophyll contents than stems and twigs, but younger twigs can reach up to 70% of the chlorophyll content of the concomitant leaves. (Pfanz, H. et al., Naturwissenschaften 89:147-162, 2002) In one test of 20 woody species, leaf chlorophyll ranged between 20 and 40 μg cm⁻² whereas corticular values ranged between 2 and 9 μg cm⁻². (Dima, E. et al., Trees 20:515-521, 2006)

Essentials for Photosynthesis.

The cortex also has nutrients, water, light and carbon dioxide (CO₂) in abundance, the essentials to drive photosynthetic reactions. (Pfanz, H. et al., Naturwissenschaften 89:147-162, 2002) Nutrients and water are supplied via the phloem, but access to light is not so evident. Old thick bark absorbs most light; however, the younger, thinner bark of stems and twigs allows 30-50% of the incident photosynthetically active radiation (PAR) to penetrate to the chlorenchyma-10% at wavelengths shorter than 500 nm, but rises with increasing wavelength to 40% of red light transmitted. (Pfanz H. et al., Progress in Botany, 62:477-510, 2001) Lastly, CO₂ is a by-product of mitochondrial respiration of the living cells, converting stored carbohydrates to fuel metabolism for growth and maintenance, and since bark has a high resistance to gas diffusion, the CO₂ is trapped there.

Function of the Chlorenchyma.

Internal stem and twig CO₂ production greatly exceeds outward diffusion resulting in high CO₂ concentrations which can be 500 to 800 times more than in leaves or atmosphere—up to 26%. (Pfanz H. et al., Progress in Botany, 62:477-510, 2001) Chlorenchyma perform multiple functions: first, re-fixing the internally produced CO₂ before it is lost through the periderm (thus conserving the carbon by compensating for 60 to 90% of potential respiratory loss); second, the photosynthesis produces extra carbohydrates for metabolism; third, this enriches internal oxygen (02) which is needed for respiration helping to avoid the danger of hypoxia within these plant organs; and fourth, because CO₂ has acidifying properties it causes acid stress in plant tissue when it is present in extremely high concentrations which can also inhibit pH-sensitive reactions in the Calvin cycle, so photosynthesis utilizes CO₂ and increases internal 02, reducing these risks (Pfanz H. et al., Progress in Botany, 62:477-510, 2001; Aschan, A. et al., Flora 198:81-97, 2003).

Photosynthetic Activity During Winter.

Through the autumn, nutrients and carbohydrates are transferred and stored in woody tissues. The onset of dormancy and the total loss of leaves does not mean a total collapse of the photosynthetic ability for trees as chlorenchyma in the stems and twigs are still able to photosynthesize. Some trees flower in the leafless state during the early spring, and even if they flower shortly after leaves appear, it takes 4-6 weeks after bud break for leaves to reach maximum photosynthetic activity. If most of the energy reserves stored in autumn are already nearly depleted by spring, an extra supply of carbohydrates via corticular photosynthesis can be vital to good bud break, flowering and fruit set. One study found the winter assimilation could account for 80-110% of the respiration. (Pfanz, H. et al., Progress in Botany 62: 477-510, 2001; Damesin, C., New Phytologist 158:465-475, 2002)

Functional Limitations of Microclimate.

However, the efficacy and protection of the corticular photosynthesis depends highly on the microclimate conditions of the bark, which can be modified by the disclosed compositions and methods.

Bark temperature is influenced by a number of factors. One, bark temperature is dependent upon air temperature, wind velocity, site specific conditions and importantly for dormancy, solar irradiance and outer-bark color. In a winter leafless state, dark colored bark temperature on the sun-exposed south side can easily reach more than 20° C. above the air temperature leading to excessive internal temperatures sometimes causing irreversible damage. (Pfanz, H. Progress in Botany 62: 477-510, 2001) Two, the optimal internal stem temperature for photosynthetic CO₂ re-fixation is between 20 and 30° C. (Pfanz, H. et al., Naturwissenschaften 89:147-162, 2002)

Three, though optimal photosynthesis is over a wide range, generally limiting the higher is better for respiration increases exponentially with temperature, consuming extra stored carbohydrates (Pfanz, H. et al., Naturwissenschaften 89:147-162, 2002) as does premature cycling in and out of endo-dormancy in late winter related to bark temperature increases, increasing CO₂ production. Four, even though stems transpire less than 1% of leaves, maintaining good water status for maximum photosynthesis can be an issue as water is lost through lenticels, leaf scars, buds scales and pruning wounds which intensifies on sunny low humidity winter days. Lowering bark temperature reduces the vapor pressure drawing water out of the bark (Pfanz, H. et al., Naturwissenschaften 89:147-162, 2002).

A sufficient quantity of PAR (photosynthetically active radiation) has to penetrate the outer bark layers to reach the light harvesting complexes in the thylakoid membranes inside the chloroplasts of the chlorenchyma. Bark transmission varies between less than 10% and almost 50% of incident light, depending on the wavelength, the tree species and the especially, the age of the stem segment since with a few exceptions light transmission is drastically reduced with advancing age (Pfanz, H. et al., Progress in Botany 62: 477-510, 2001; Aschan, G. et al., Flora 198:81-97, 2003). Because of this, thylakoid frequency and stacking degree in cortex chloroplasts resemble that of shade leaves which receive only 5% incident light, though the quality of light is predominantly red-enriched, because bark strongly and selectively absorbs the shorter wavelengths (Dima, E. et al., Trees 20:515-521, 2006); most all of the 665 nm red light is absorbed in the cortex for photosynthesis (Pfanz, H. et al., Naturwissenschaften 89:147-162, 2002).

Light-response curves of corticular photosynthesis for young, intact twigs of beech show light saturation between 400 and 510 μmol photons m⁻²s⁻¹, whereas light saturation of deciduous shade leaves is about 200-500 μmol photons m⁻²s⁻¹. (Pfanz, H. et al., Naturwissenschaften 89:147-162, 2002) However, if the incident light was corrected for the percentage of transmitted light (32% in recent-year twigs or 19% in one-year-old twigs), the real in situ light saturation would have been between 60 and 80 μmol photons m⁻²s⁻¹ at the interior cortex level indicating that the corticular photosynthesis is performed by extremely shade adapted chloroplasts. (Pfanz, H. et al., Progress in Botany 62:477-510, 2001) Even reproductive structures like buds have a 1 to 3 times higher photosynthetic assimilatory capacity than the leaves of the same plant species (Aschan, G. et al., Flora 198:81-97, 2003).

Similar results to the beech twigs above were obtained with isolated periderms and chlorenchymes where, depending on the species, approximately 300-500 μmol photons m⁻²s⁻¹ was sufficient for maximum bark photosynthesis. At less than 300 μmol photons m⁻²s⁻¹ photosynthesis was linearly dependent on the light applied; at more than 500 μmol photons m⁻²s⁻¹, photo damage occurred. Therefore, photo damage is expected in exposed tissues that are not well protected against a surplus of light, such as the youngest twigs and buds at the terminal ends of branches in position to receive maximum light. (Pfanz, H. et al., Progress in Botany 62:477-510, 2001).

Consequently, during dormancy with short days and low light angles, and only a small percentage of the light reaching the interior cortex but too much on exposed tissues causing damage, makes a unique challenge to get more light distribution and reduce the chance of photo damage. This challenge is met by the disclosed compositions and methods. The calcium carbonate crystals transmit about 96% of the incident light while diffusing it in multiple directions so that the softened light can strike the tissues at multiple angles, thus increasing the chance of hitting chloroplasts to maximize photosynthesis and at the same time protecting more exposed tissues from photo damage.

The modification of the light and thus the microclimate of the buds, which leads to increased chilling hours and cooler bark temperatures, just as importantly redistributes nearly all the incident light. That not blocking, but diffusing is significant to dormancy response, is shown in a side by side study done on pistachios (shown below in Table 12). The impact on harvest correlated with how well the disclosed composition kept the bud and bark cooler and redistributed the incident light.

Initial studies provided proof-of-principle results in that the foliar treatments disclosed herein gave rise to inhibition of chloroplast strong light avoidance movement. In further studies (referred to as Method No. 2), a 405 nm diode laser having a nominal output power of 10 mW was used, in place of a high power 405 nm diode laser. The 10 mW laser has an adjustable beam size, and the size was adjusted to provide a laser power density in the range of 2-4 mW/cm². These power densities were found to be adequate to provide the desired chloroplast strong light avoidance movement in the leaves of several plants of interest. Using the new laser and method, a power-reducing beamsplitter is not needed.

The procedure using the 10 mW laser is as follows:

a. A bare leaf (treated with distilled water) is mounted in the leaf-holder, and a bare-leaf laser transmission scan is carried out.

b. Keeping the position of the laser beam (now blocked) fixed and the leaf position in the holder fixed, the portion of the leaf exposed to the laser beam is treated with a desired treatment to achieve inhibition of chloroplast strong light avoidance movement.

c. A 15-30 minute wait time allows equilibration of the inhibition of chloroplast strong light avoidance movement treatment and re-accumulation of leaf chloroplasts under the chloroplast weak light accumulation condition of the weak laboratory lighting.

d. A treated-leaf scan is carried out.

Under this procedure, a normalization process is not needed for data analysis. Treated and untreated leaf areas are identical, and the two laser beams used for the transmission scans are identical; therefore, there is no need for data normalization.

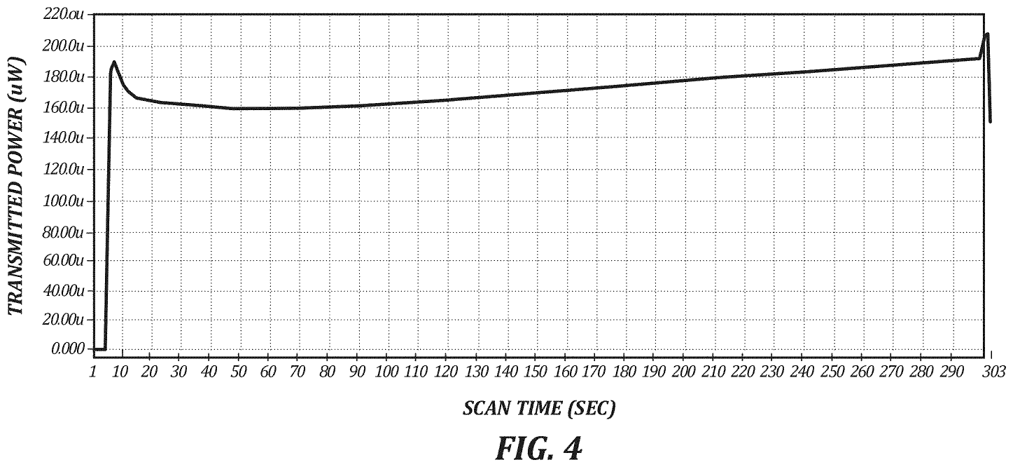

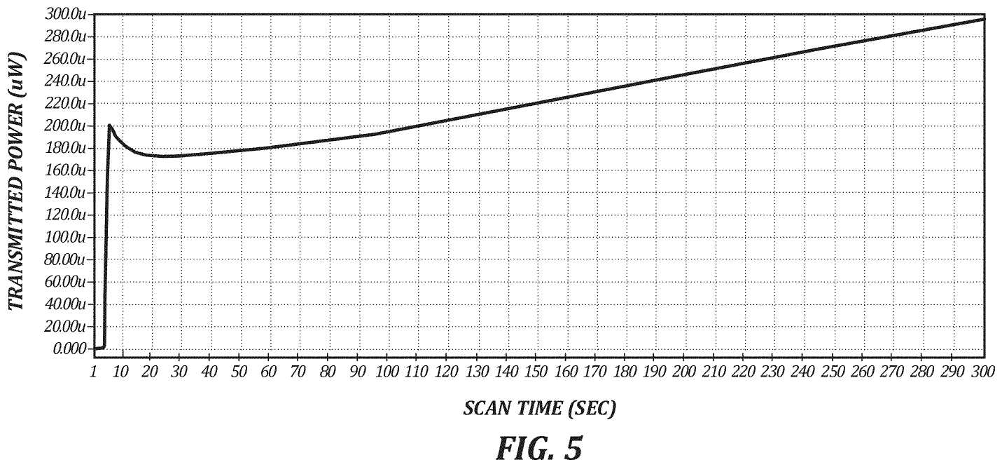

The straight-line portions of the temporal scans of a leaf's laser transmission displayed in FIGS. 4 and 5 measure the rate of chloroplast strong light avoidance movement for the bare half and the treated half, respectively, of an Oxalis leaf. In previous work involving measurements of bare-leaf chloroplast strong light avoidance movement (Aggarwal, C. et al., PLOS ONE 8:1-11, 2013; Wada, M. et al., Methods in Molecular Biology 774:87-102, 2011), a straight-line increase in leaf transmission, due to chloroplast strong light avoidance movement, was found to be maintained for roughly 10 minutes. After 10 minutes, the rate of increase of leaf transmission decreased with time, and, within a few minutes, has decreased to zero. When leaf transmission has become constant with time, chloroplast strong light avoidance movement has stopped entirely. As indicated in the data in FIGS. 4 and 5, chloroplast strong light avoidance movement stoppage occurs for a smaller value of leaf transmission for a treated leaf than is the case for a bare leaf.

For leaves from nasturtium, impatiens, and peppermint plants, transmission scans for treated leaves do not have straight-line increasing transmission segment. Thus, a treated leaf slope, for comparison with the slope of the straight-line segment of the bare leaf transmission scan, cannot be measured. Consequently, the methods of the disclosure involve evaluating the chloroplast strong light avoidance movement for the two laser transmission scans, for a given leaf, by measuring the difference in transmission value between the largest value of transmission, representing stoppage of chloroplast strong light avoidance movement, and the minimum in transmission value occurring after a few tens of seconds of laser transmission (shown in FIGS. 4 and 5). Using this method of data analysis in peppermint plants, values of inhibition of chloroplast strong light avoidance movement are shown in the following Table 1 and discussed further in Example 5.

TABLE 1

| | Average | |
|---|---|---|
| | Chloroplast | Number |
| | Movement | of |
| | Inhibition | Temporal |
| Leaf Treatment | Factor | Scans |
| CRC058 w/RDI-S (5%) + 300 ppm 5, 10, | 9 | 1 |
| 20 nm TiO₂ | | |
| CRC058 w/3395 (5%) w/150 ppm 10 nm TiO₂ | 2.5 | 1 |
| 11Hx w/lec. (3% sol'n) w/5% RDI-S | 1.6 | 4 |
| CRC058 w/3395 (5%) | 1.4 | 2 |
| CRC90 w/RDI-S (5%) + 150 ppm 20 nm TiO₂ | 1.1 | 2 |
| CRC058 w/RDI-S (5%) w/150 ppm CCR200 | 1.0 | 3 |
| (20 nm TiO₂) | | |
| CRC90 w/RDI-S + PCE | 0.5 | 2 |
| RDI-S + 20 nm TiO₂ (5%) | 0.5 | 2 |
| “J” CaCO³ 11HX | 0.5 | 1 |
| “g” RDI-S + PCE + 150 ppm 20 nm TiO₂ | 0.3 | 2 |
| 11Hx w/lec. (2% sol'n) | 0.3 | 1 |
| CRC058 + lec. (2%) | 0 | 3 |

These and other aspects of the disclosure are discussed in detail below and in the Examples.

1. Methods and Equipment for Measuring and Documenting Reduction of Chloroplast Light-Avoidance in Plants.

It is known in the art that the arrangement of foliar chloroplasts changes when the intensity of foliar illumination is changed. Under weak illumination, foliar chloroplasts move to an arrangement which achieves maximum exposure of chlorophyll chromophores to the incident light. In contrast, high intensity of incident light gives rise to avoidance movement by foliar chloroplasts. These movements can include both translation (movement relative to the plane of the leaf) and rotation (three dimensional position changes).

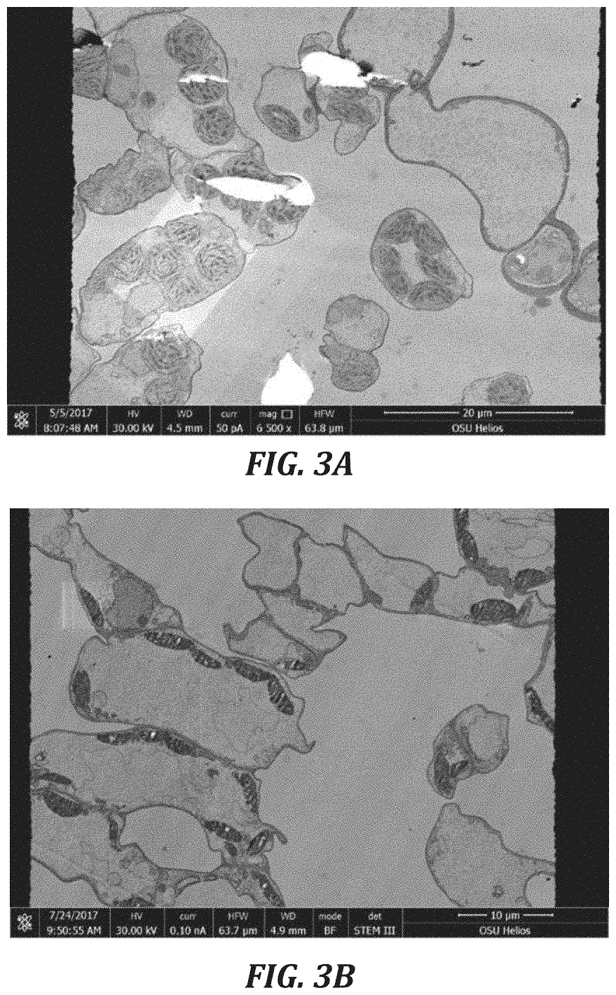

The foliar chloroplast avoidance movement is triggered and controlled by high intensity blue or ultraviolet light. For the procedures described herein, an intense beam of linearly polarized light of 405 nm wavelength from a high-power diode laser or a low power laser is used to illuminate plant leaves of interest. The high powered diode laser output power is over ten times the noon sun at the equator, at the 405 nm wavelength. Beamsplitting is used to obtain 405 nm light intensities equal to or slightly greater than that of equatorial noonday sunlight at 405 nm. Two different 405 nm diode lasers are used as shown in FIGS. 2A and 2B. One is high powered and the second is low powered 405 nm diode laser. The color of 405 nm light is violet, and this wavelength is very close to near ultraviolet. A second apparatus uses a low power 10 mW 405 diode laser having an adjustable beam size, and no power-reducing beamsplitter.

The procedures described herein are carried out in a photographic darkroom, where the only light is that of the diode laser and the screen backlight of the computer or other device used for data acquisition and storage. For 75 to 150 micron plant leaves, the fraction of the diode laser light transmitted by the plant leaf is readily measured using a photodiode having a diameter roughly equal to that of the laser beam. The measured light transmission fraction is of the order of 1%.

The principal feature of the procedures described herein is the measurement of the variation of light transmission by a leaf with time. The plants used in the experiments are kept in the dark or in weak light, then a leaf is removed from the plant and mounted on a dampened leaf holder so that the plane of the leaf is perpendicular to the 405 nm linearly polarized light beam from the diode laser. Two suitable experimental setups are illustrated schematically in FIG. 2.

The untreated, or bare, ½-leaf, under the spotlight of the 405 nm diode laser, provides zero inhibition of chloroplast movement, that is, the chloroplasts move out of the spotlight as fast as nature permits. The treated ½ leaf is compared with its bare (untreated) partner. The number zero (zero inhibition of movement) is assigned to all bare ½ leaves. The measure of chloroplast movement inhibition used herein is the comparison of the slope of the straight line portion of the transmission scan of a treated ½-leaf with the corresponding slope of its untreated partner. If both leaf halves are bare, the slope ratio is unity, i.e., the two slopes are the same. To obtain the number 0 for the chloroplast movement inhibition of this experiment, the slope ratio of 1 is taken, and the number 1 is subtracted.

For all treated ½-leaves, the slope of the straight line portion of the transmission scan should be smaller than the corresponding slope for its partner bare ½-leaf, because the leaf treatment inhibits chloroplast movement. To be consistent across experiments, the data analysis should also be kept consistent. The chloroplast movement inhibition number is bare ½-leaf slope divided by treated ½-leaf slope minus 1. If the leaf treatments were perfect, the slope of the straight line for the treated ½-leaf would be zero, the slope ratio would be infinite and the slope ratio minus 1 would be infinite.

With no leaf in the leaf mount, and the laser beam oriented as shown in FIG. 2A, the beam passes through the two one-centimeter diameter circular openings in the leaf mount and falls perpendicularly on the active area of the photodiode, which is slightly larger in diameter than is the laser beam. Measured laser beam intensities are slightly larger than 10 mW/cm².

For Method No. 1, before exposure of a mounted leaf to the laser beam, the power-reducing optical setup is used to rotate the laser beam away from the leaf mount front opening. Thus, the leaf has been exposed only to weak light. A temporal scan of the laser light transmitted by the leaf proceeds as follows:

1. The darkroom lights are turned off.
2. Data acquisition and storage is initiated using suitable software, such as Thorlabs software (Thorlabs, Inc., Newton, N.J., USA). LabVIEW2011 code is part of Thorlabs PM100USB detector interface unit used herein.
3. The laser beam is rotated to pass through the front opening of the leaf mount, exposing a 1 cm diameter piece of the leaf to the 10 mW/cm² laser beam.
4. Acquisition and storage of leaf transmission data is continued for a desired time interval, usually ranging between 2 and 30 minutes.

Using Method No. 1, a typical temporal scan of the transmission (T) of 405 nm diode laser light by an arbitrarily selected Oxalis leaf is shown in FIG. 5. If the only action of and within foliar chloroplasts was light avoidance, the intensity of foliar light transmission should increase monotonically with time. (Wada, M. et al., Methods in Molecular Biology 774:87-102, 2011). As the foliar chloroplast light avoidance process proceeds, the number of chlorophyll chromophores exposed to light decreases, thereby decreasing leaf absorption and increasing leaf transmission.

The initial decrease in foliar transmission seen in FIG. 5 is due to rotation of chlorophyll chromophore transition dipole moments (TDMs) toward alignment with the direction of polarization (P) of the laser light (Kadota, A., et al., Plant Cell Physiol., 30:523-531, 1989; Bryant, D. A. et al., J. Phys. B—Atomic, Molecular and Optical Physics 51:49, 2018). An increase in alignment of TDMs with P would yield an increase in light absorption by chlorophyll chromophores, and a corresponding decrease in transmission. Thus, the interpretation of the data of FIG. 5 is the occurrence of the two competing processes of TDM alignment and strong light and foliar chloroplast avoidance movement. This is verified with two independent observations, but the alignment of TDMs remains a conjecture with P remaining constant.

During the latter part of the leaf transmission scan displayed in FIG. 5, the transmission, T, increases linearly with increasing time. It is reasonable to assume that, at these later times, the rate of change of TDM alignment can be neglected, and, instead, the observed linear rate of change of transmission is due exclusively to the foliar chloroplast light avoidance movement. This measured rate of change of transmission thus provides a numerical value for the rate of foliar chloroplast light avoidance motion.

The light source initially in use for measurements of inhibition of foliar chloroplast movement was a high pressure mercury (Hg) arc lamp (available from general light source suppliers). The Hg arc lamp has its most intense light emission within sharp peaks (referred to as emission lines) located at wavelengths, in nanometers, of 365, 405, 436, 490, 546, and 579. Light emission at the lowest four of these wavelengths initiates foliar chloroplast movement; therefore, qualitatively, use of the Hg arc lamp and the 405 nm diode laser for measurements of inhibition of foliar chloroplast movement both yield the same results.

The four distinct advantages of the two diode lasers are that their light intensity (in use) is roughly twice that of the Hg arc lamp; the light beam is perfectly collimated (which is not achievable for the Hg arc lamp); and the light emission has perfect linear polarization, whereas the Hg arc lamp emits unpolarized light, and the electromagnetic (EM) fields of the lasers are perfectly coherent whereas the Hg lamp has a very low value of EM field coherent. Use of the diode laser as a light source provides a significant reduction in time needed for data acquisition and a simpler procedure for data analysis.

Two different 405 nm diode lasers, having differing power outputs, are used herein. Light from the 405 nm diode laser is coherent, whereas light from the Hg arc, low coherent, as with sunlight, is totally incoherent.

As a sample of the performance of the methods described herein, a transmission scan for a treated Oxalis leaf was performed. As indicated above for Method No. 1, reliable reproducible data comparing a temporal scan of transmission for a treated leaf with that for an untreated leaf is obtained preferably when the same leaf is used for both scans. Different leaves are of different thicknesses, they have different growth histories, and other naturally occurring variables. Thus, for the comparison of temporal scans, one half of a leaf is treated and the other half of the same leaf is left untreated.

A number of abbreviations are used in the Figures and Tables to describe the treatments. These abbreviations are as follows:

### BLC: Bare Leaf Control

### CCCDGF: 4% Calcium Carbonate Calcite Dry Ground Formulation

### CCCWGF: 4% Calcium Carbonate Calcite Wet Ground Formulation

CCCDGFW-TA, TB, TC, etc. as defined below.
4% Calcium Carbonate Calcite Dry Ground Formulation with Titanium Dioxide Candidate
CCCWGFW-TA, TB, TC, etc: 4% Calcium Carbonate Calcite Wet Ground Formulation with Titanium Dioxide Candidate as defined below.

### NSS45: Neutrogena® (Johnson & Johnson, New Brunswick, N.J. USA)., Sunscreen

SPF tested, undiluted.
CRC058 and CRC90 are calcium carbonate products obtained from Columbia River Carbonates (Woodland, Wash., USA).
4% solutions refer to solutions having 96% water; 2% solutions refer to solutions having 98% water.

### 5% w/w Titanium Dioxide Samples and Sources:

### A: Huntsman Altiris 550 (Huntsman LLC, The Woodlands, Tex. 77380)

### B: Cinkarna CCR 220Mn (Celje, Slovenija)

### C: Huntsman Hombitec 400WP (Huntsman LLC, The Woodlands, Tex. 77380)

### D: Sachtleben RDI-S(Rockwood Holdings, Inc., Pori, Finland)

### E: R2145 (Specialty Minerals, Lucerne Valley, Calif., USA)

### F: R3395 (Specialty Minerals, Lucerne Valley, Calif., USA)

### G: PR900 (Specialty Minerals, Lucerne Valley, Calif., USA)

### H: ½ RDI-S &½ 220 Mn (Rockwood Holdings, Inc., Pori, Finland)

### I. Cinkarna CCR 110 (Celje, Slovenija)

### J. Cinkarna CCR 200 N (Celje, Slovenija)

### K. R2295 (Specialty Minerals (Lucerne Valley, Calif., USA)

The titanium dioxide used has Al₂O₃surface treatment and may be doped or undoped with manganese or nitrogen. The preferred TiO₂ has a size range of 10 nm to 500 nm.

In FIGS. 4 and 5, the slope of the straight line portion of FIG. 5 is larger than the slope for the corresponding portion of FIG. 4. Chloroplast motion is greater for FIG. 5 than it is for FIG. 4. The inhibition of chloroplast motion can be evaluated by such comparison. FIG. 4 has more inhibition of chloroplast motion than does FIG. 5 because the ½ leaf for FIG. 4 is treated whereas the ½ leaf for FIG. 5 has no treatment, i.e., it is a bare ½ leaf.

The treated-leaf temporal scan of transmission (T) to be compared with the untreated-leaf scan displayed in FIG. 5 is shown in FIG. 4. The leaf was treated with CCCWGW-TD. In FIG. 4, the value of T at the early peak, near zero time, is lower than it is for the corresponding peak in FIG. 5. The added scattering/diffraction of light provided by the foliar treatment gives rise to a reduction of the value of T for all values of scan time. However, the alignment of the laser beam with the circular aperture in the leaf mount is not perfect; thus, a small misalignment is to be assumed.

In order to make the comparison of line slopes for the two different temporal scans of T, any differences in the intensity of light incident upon the foliar chloroplasts must be taken into account. This is done by normalizing the measured rate of change for the linear portion of a given temporal scan of T to the value of T at its peak near the zero of time. A normalization procedure is not required for the second method, because using the second method, neither the leaf position nor the position of the laser ever move. Leaf position and laser beam position when the leaf is treated are exactly the same as it is when the leaf is bare.

Even without the normalization procedure, it is seen that the rate of foliar chloroplast light avoidance movement is smaller in FIG. 4 than it is in FIG. 5. This result shows that the foliar treatment for the data of FIG. 4 inhibits the foliar chloroplast light avoidance movement. If the scans of FIGS. 4 and 5 were repeated for a different leaf, from the same plant, having the same leaf treatment applied to the treated one half of the new leaf, both straight-line slopes may differ from those of FIGS. 4 and 5. However, the normalized slope ratios for the two sets of data are expected to provide nearly equal numbers. A final number is obtained by averaging normalized slope ratios obtained from two or more sets of scans.

The leaf transmission data described herein is used to determine and compare the effectiveness of different leaf treatments in their inhibition of foliar chloroplast movement. FIGS. 4 and 5 illustrate data analysis. The normalized slope of the straight line portion of the data of FIG. 5 is 0.79/(300 sec), and that for FIG. 4 is 0.24/(300 sec). Division of these two numbers yields a bare-leaf/treated-leaf slope ratio of 3.29. If the leaf treatment yielded a total prevention of foliar chloroplast movement, the slope of the straight line portion of FIG. 4 would be zero. In this “perfect prevention” case, the bare-leaf/treated-leaf ratio would be infinite.

To complete the data analysis, it is desirable to use the number zero for the bare-leaf/bare-leaf foliar chloroplast movement prevention ratio. Therefore, the final number in use to represent the ability of a given leaf treatment to prevent foliar chloroplast movement is the bare-leaf/treated-leaf straight line slope ratio minus one. Consequently, the final number for foliar chloroplast movement prevention represented by the data of FIGS. 4 and 5 is 3.29−1=2.29.

2. Treatments to Reduce and Prevent Foliar Chloroplast Movement in Response to Bright Light.

The treatments disclosed herein consist of mixtures of CaCO₂ and TiO₂ nanoparticles, together with surfactants, in a water-based flowable agricultural formulation solution which is applied, for example sprayed, for ideally monolayer coverage of plant leaves. The disclosed foliar treatments have at least two important effects: they increase foliar scattering, or diffraction, of light; and they inhibit the light avoidance movement by foliar chloroplasts. This light-avoidance movement is known in the art (Psaltis, D., et al., Apl Photonics 1:020901-1-020901-11, 2016; Wada, M., Proc. Jpn Acad., B 92:387-411, 2016).

Taken together, these two effects increase the efficiency of photosynthesis within plant leaves, and thereby enhance CO₂ sequestration. The increase in diffraction/scattering of light increases the participation in photosynthesis by foliar chlorophyll chromophores (Gal, A., et al., Adv. Mater. 24:OP77-OP83, 2012); and the absorption of blue and near UV light by the TiO₂ nanoparticles reduces the light avoidance movement by chloroplasts.

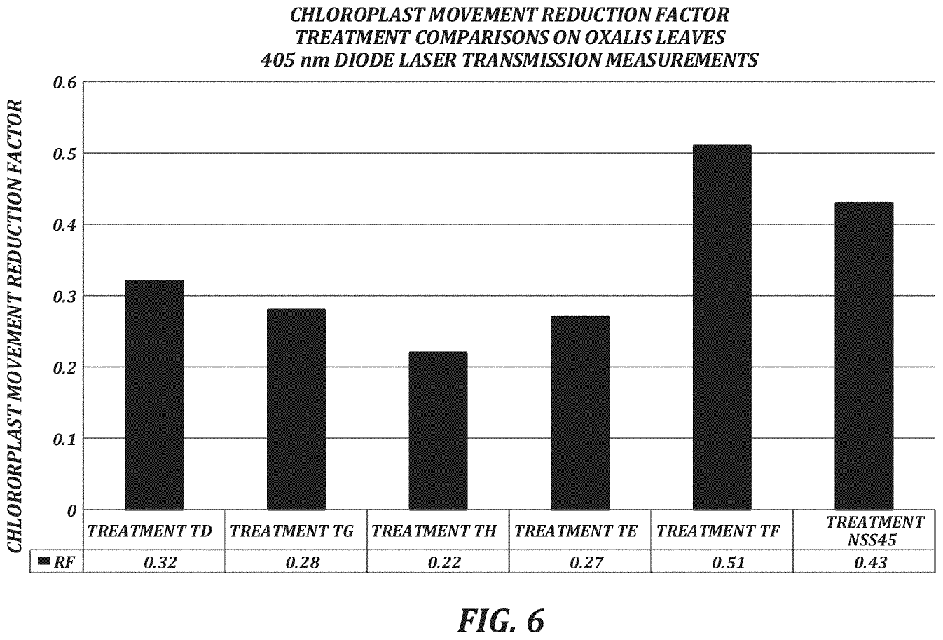

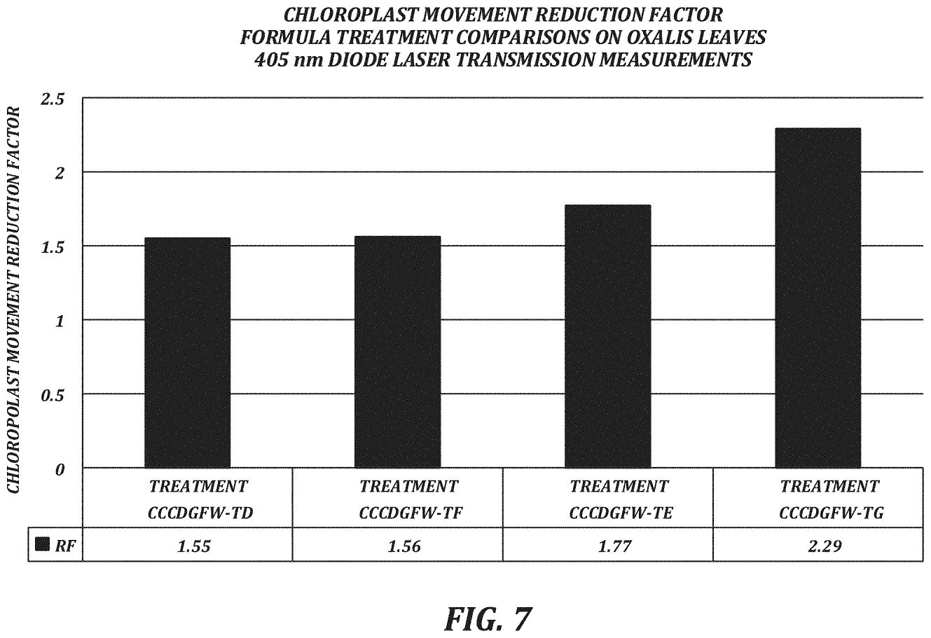

Further results are illustrated in FIGS. 6 and 7, using Oxalis and Nasturtium leaves, respectively, and exposure to 405 nm diode laser light. In FIG. 6, the chloroplast movement reduction factor was below 0.5 for the following treatments: 4% Solution of TD, TE, TG, and TH. However, for CCCDGFW-TD (calcium carbonate and RDI-S rutile titanium dioxide), the relative reduction factor was significantly increased to 2.25. The results shown in this Figure demonstrate the improvement using calcium carbonate plus titanium dioxide in formulation, over either one alone.

FIG. 7 shows comparable results for chloroplast movement reduction factor in Oxalis leaves. The treatments are various titanium dioxide in CCCDGF.

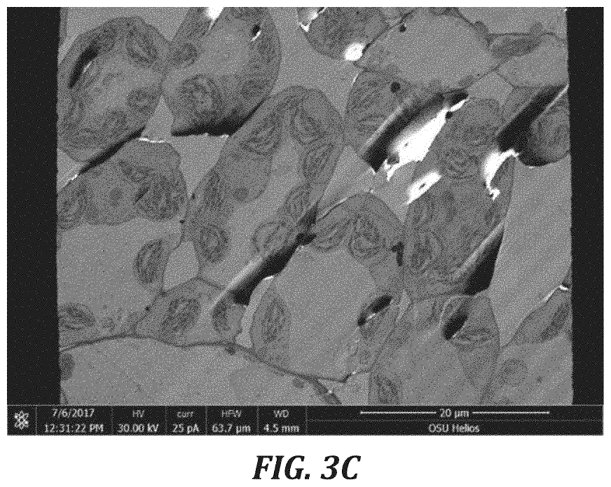

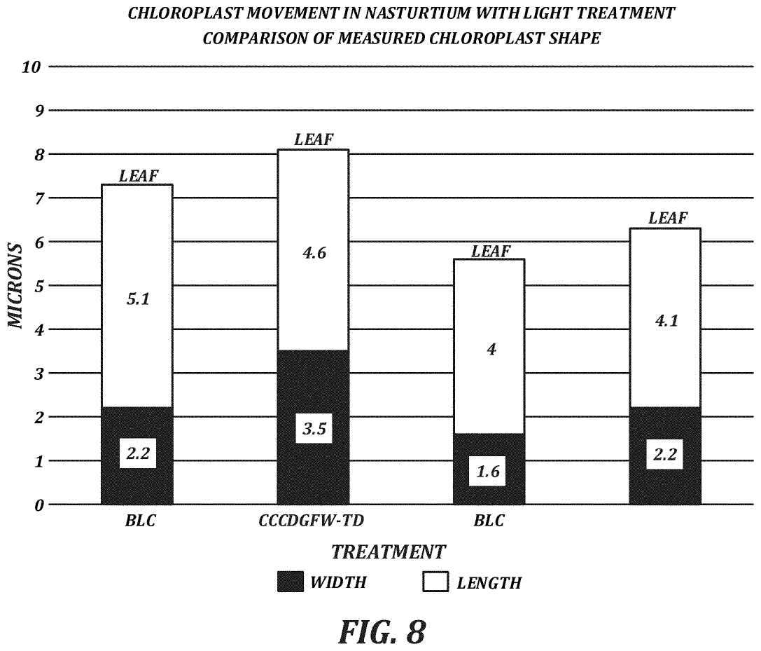

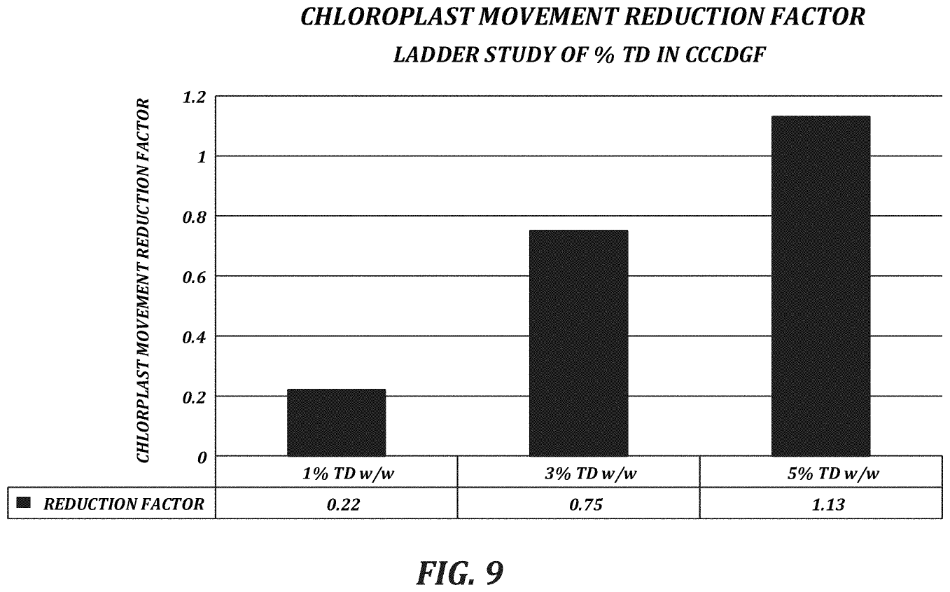

FIG. 8 illustrates chloroplast dimensions after treatment of Nasturtium leaves as shown below in Table 2. The treated and untreated leaf samples were compared to show chloroplast photorelocation in measuring the width and length, confirming that the chloroplasts move directly toward the cell wall, extending length and decreasing in width as shown in the SEM photos such as in FIG. 3.

TABLE 2

| Treatment | Width (nm) | Length (nm) |
|---|---|---|
| Bare leaf control | 2.2 | 5.1 |
| CCCDGFW-TD | 3.5 | 4.6 |
| Bare leaf control | 1.6 | 4 |
| CCCDRFW-TD | 2.2 | 4.1 |

The new foliar treatments described herein are evaluated for an effect on foliar temperature. Leaf temperatures can be measured using a variety of methods, including an IR Temperature Gun, a FLIR IR camera attachment for cell phones, and thermocouples inserted into leaf stems. The first two methods provide instantaneous readings over broad areas, and the third method is preferred for longer term (hours, days, weeks) continuous recording of leaf temperature differences between treated and untreated leaves.

IR temperature guns are available from several commercial sources, including but not limited to Cole-Parmer (Vernon Hills, Ill. 60061, USA); and Global Industrial (Port Washington, N.Y. 11050, USA).

For the second method, a simple and inexpensive addition to cell phone cameras consists of an IR imaging attachment such as the FLIR ONE, available for example from FLIR Systems, Wilsonville, Oreg., USA.

A third method utilizes thermocouple wires inserted directly into the stems of leaves. Data recorders can be placed in waterproof containers such plastic bags to be secured onto the plant and left for days or weeks at a time recording differences in the treated and untreated samples. In one use of this method, data recorders are used with a thermocouple wire which is on a mini plug that attaches to the recorder, which takes a sample on a regular schedule, for example every five minutes. Results obtained using such a method are described in Example 6 herein.

A method of measuring leaf temperature can be chosen based on the specific experiment or study, for example one of the first two methods would be suitable for a one-time or short-term measurement in the laboratory or experimental greenhouse, and the third method would be suitable for longer-term measurements, such as in a commercial greenhouse, field, or forest where measurements do not require constant monitoring.

The energy of absorbed sunlight is distributed among photosynthesis, fluorescence, and heat dissipation. On a hot sunny day, fluorescence can reasonably be neglected (Martinazzo, G. M., et al., Braz. J. Plant Physiol., 24:237-246, 2012). Thus, the decrease in heat dissipation which must accompany an increase in photosynthesis (energy conservation) provides a lowering of foliar temperature. At high ambient temperatures, the decrease in evaporative water loss provided by the lowering of foliar temperatures improves plant health and increases CO₂ sequestration.

The disclosed methods and compositions enhance the biological effect of photosynthesis. Benefits include enhanced plant growth, increased carbon capture and sequestration, corresponding increased release of oxygen, and reflection of solar radiation of wave lengths less than 700 nm. The disclosed methods are designed to be more economical than existing carbon capture methods because they do not require advanced technology for ambient air CO₂ Capture, Geo-Storage, specialized regulations, special infrastructure or transportation needs typically associated with more traditional carbon sequestration and capture methods. Another benefit is improved water use efficiency by treated plants, described in Example 6.

A further advantage of the compositions and methods disclosed herein relates to a multiplier effect of the treatment. Example 4 provides data showing that five tree species treated with a composition of the disclosure had higher chlorophyll levels, as well an enhanced growth. Following treatment, these trees have enhanced capacity to absorb CO₂. Based on an average 20% increase in chlorophyll concentration per growing season, over a number of years a treated tree will have significantly more CO₂ capture and utilization than an untreated tree. A comparable effect will be seen in other species, including ornamental and agricultural plants.

Two specific formulations, one using dry ground calcium carbonate and the other using wet ground calcium carbonate, can be prepared as follows (Tables 3 and 4). The procedure can use standard vacuum centrifuge equipment as needed for de-aeration. An additional formulation is referred to as “calcium with calcium acetate” having the formulation shown in Table 5 below.

TABLE 3
Dry ground: CCCDGFW-T formulation method

| | | Procedure - Add in order |
|---|---|---|
| Ingredient | W/W % | below to paddle mixing vessel |
| Potable water | 30.08 | Begin Agitation |
| Dispersogen PCE | 0.95 | Mix to disperse |
| Soy Lecithin | 2.71 | Mix to disperse |
| Sodium carbonate | 0.38 | Mix to disperse |
| CCCDG | 58.43 | Mix to disperse |
| Alcohol (ethanol or | 2.14 | Mix to disperse |
| isopropanol) | | |
| Clove Oil | 0.19 | Mix to disperse |
| Guar Gum | 0.12 | Mix to disperse + 1 hour |
| | | De-aerate at least one hour |
| Titanium dioxide | 5.00 | Shear mix to disperse |
| Total | 100.00 | |

TABLE 4
Wet around: CCCWGFW-T formulation method

| | | Procedure - Add in order |
|---|---|---|
| Ingredient | W/W % | below to paddle mixing vessel |
| Potable water | 14.44 | Begin Agitation |
| Esperse 366 | 1.00 | Mix to disperse |
| Titanium dioxide | 5.00 | Mix to disperse |
| CCCWG @ 74% Calcium | 78.96 | Mix to disperse |
| Carbonate | | |
| Silicone PMX200 | 0.25 | Mix to disperse |
| Mergal K10N | 0.15 | Mix to disperse |
| Mergal 186 | 0.10 | Mix to disperse |
| Guar Gum | 0.10 | Mix to disperse + 1 hour |
| Total | 100.00 | |

TABLE 5
Calcium with Calcium Acetate

| Ingredient | Wt % |
|---|---|
| Potable water | 32.7 |
| Calcium hypochlorite | 0.02 |
| PCE | 0.50 |
| Esperse 366 | 1.00 |
| Calcium acetate | 3.00 |
| RDI-S Titanium dioxide | 4.00 |
| Vansil W-50 | 3.50 |
| 11 HX Calcium Carbonate | 54.5 |
| XP 2450 | 0.22 |
| Clove oil | 0.04 |
| Si Absorbe or PMX Silicone | 0.27 |
| Mergal K10N | 0.15 |
| Mergal 186 | 0.10 |
| Total | 100.00 |

Procedure for Mixing for Table 5:

1. Load water and begin agitation.

2. Load calcium hypochlorite and continue agitation.

3. Load PCE and mix 2 hours to hydrate.

4. Reduce agitation speed to minimum, slowly add Esperse 366 and mix slowly for 10 minutes to disperse well.

5. Load clove oil and continue mixing.

6. Load silicone (Si Absorbe or PMX 200) and continue mixing.

7. Load Mergal K10 N and continue mixing slowly.

8. Load Mergal 186 and continue mixing slowly for one hour.

9. Measure specific gravity at 25° C. The specific gravity should be approximately 13.3.

The specific amounts in Tables 3, 4 and 5 above are exemplary of preparations used in the methods of the Examples. The amounts can be varied according to the following ranges, Tables 6 and 7:

TABLE 6
Dry ground: CCCDGFW-T ranges for components

| Ingredient | W/W % |
|---|---|
| Potable water | 25.65-74.35 |
| Dispersogen PCE | 0.5-1.0 |
| Soy Lecithin | 2.0-3.0 |
| Sodium carbonate | 0.2-0.5 |
| CCCDG | 58-61.5 |
| Alcohol (ethanol or | 1.5-3 |
| isopropanol) | |
| Clove Oil | 0-0.2 |
| Guar Gum | 0.05-0.15 |
| Titanium dioxide | 0.5-5 |

TABLE 7
Wet ground: CCCWGFW-T ranges for components

| Ingredient | W/W % |
|---|---|
| Potable water | 8.85-20.85 |
| Esperse 366 | 0.5-1 |
| Titanium dioxide | 0.5-5.0 |
| CCCWG @ 74% Calcium | 78-84 |
| Carbonate | |
| Silicone PMX200 | 0.1-0.5 |
| Mergal K10N | 0-0.25 |
| Mergal 186 | 0-0.25 |
| Guar Gum | 0.05-0.15 |

Mergal K10N is a VOC-free, water-based preservative to prevent deterioration and degradation caused by bacteria and fungi, and Mergal 186 is a clear, water soluble liquid preservative for control of bacteria in aqueous-based systems (Troy Corporation, Florham Park, N.J., 07932, USA). Guar gum and xanthan gum may be interchanged or used in combination as a thickener, and are a non-limiting examples suitable for use herein.

The Esperse 366 product (Ethox Chemicals, LLC, Greenville, N.C. 29605, USA) is an alcohol C12-16 poly(1-6)ethoxylate. Other classes of emulsifiers such as

Esperse products having similar characteristics can optionally be substituted. As used in CCCWGFW-T formulations herein, it can optionally be used interchangeably with the emulsifier product Rheovis® AT 120 (BASF Corporation, Florham Park, N.J. 07932, USA).

Dispersogen PCE in CCCDGFW-T formulations can be used interchangeably with other dispersing agents in the chemical family of polycarboxylate ethers (Clariant Corporation, Charlotte, N.C., 28205, USA). Silicone PMX200 (Dow Corning Corp., Midland, Mich. 48686, USA) as used in CCCWGFW-T formulations herein is a silicone and can be optionally substituted with other silicones having comparable characteristics.

XP-2450 is a polyacrylic dispersing agent. Suitable polyacrylic dispersing agents include those available from Coatex (Chester, DC, USA): Ecodis™, Rheosperse™ 3620, Ecodis™ P 30, Coadis™ BR 85, Coadis™ 144 A, and Coadis™ 123 K.

3. Extrapolation to Large-Scale Carbon Sequestration by Treated Plants and Trees.

The disclosure is directed to reducing or preventing chloroplast movement which occurs in plants in response to bright sunlight. Relevant to carrying out this process on a national and global scale, the present studies of the movement of chloroplasts show that the movement can be experimentally controlled and measured, and, as a result, the capture of atmospheric CO₂ is enhanced. When this is done on the scale of agricultural and forest product growth, meaningful reduction in the Earth's atmospheric CO₂ levels are achievable. Projected calculations are provided in Examples 2 and 3.

Psaltis, D. et al. (APL Photonics 1:020901-1-11, 2016) studied the mechanism of chloroplast movement in the houseplant Calathea. In bright light, chloroplasts aggregated near the side membrane of a plant cell. However, the chloroplasts appeared evenly distributed in the cells that had not been exposed to light. By aggregating near the membrane, the chloroplasts shaded each other and dramatically reduced the light absorption cross section of the cell.

Several advantages to the plant are achieved by the chloroplasts' ability to move within the plant cells, including avoiding thermal damage, avoiding photobleaching, DNA damage, and other potential damage from high light intensity. As noted above, this reaction has been identified as “chloroplast avoidance motion.” (Kasahr, M. et al., Nature 420:829-832, 2002.) However, this avoidance mechanism is a disadvantage for the goal of maximizing photosynthesis to reduce excess atmospheric CO₂ on an internationally meaningful scale.

Further studies have demonstrated the mechanism for the chloroplast avoidance motion. When light is absorbed by chlorophyll, ATP and the cofactor dihydronicotinamide-adenine dinucleotide phosphate (NADPH) are produced in the thylakoid of the chloroplast. “Thylakoid” refers to the intracellular compartments in which chloroplasts are embedded. Excess hydrogen cations are produced and transferred across the thylakoid membrane.

This process generates an electrochemical proton gradient, which is catalyzed by the ATP synthase enzyme to generate ATP. The ATP powers the molecular motors in conjunction with proteins in the PHOT 1 and PHOT 2 processes. Although the chloroplast avoidance movement may seem arbitrary when strong light is present, it results in accumulation of chloroplasts at the edges of the cells, protection of the chloroplasts, and a consequent reduction in photosynthetic activity.

The chloroplast movement allows the leaf to dynamically adapt to optimize use of the available solar energy, while minimizing harm from overexposure to light. However, from the perspective of using plants commercially to reduce atmospheric CO₂, the chloroplast avoidance motion is a disadvantage.

The compositions and methods of the present disclosure provide a solution to this disadvantage, by light scattering and reducing and/or preventing the daytime avoidance of light. As discussed in detail in the Examples, Enhanced CO₂ Capture and Storage (referred to herein as ECCS) was achieved by treating plant leaves with a flowable agricultural formulation of calcium carbonate and titanium dioxide. Although the compositions are not limited to the particular sources of materials disclosed herein, a suitable source of titanium dioxide, as used in the Examples, is Sachtleben (Rockwood Holdings, Inc., Pori, Finland). The product (also referred to herein as “T-D”) is referred to as Sachtleben RDI-S, alumina surface treated rutile titanium dioxide pigment, CAS number 13463-67-7. “Rutile” refers to a mineral composed of titanium dioxide and having one of the highest refractive indices among known crystals.

This titanium dioxide treatment product has the following properties as shown in Table 8:

TABLE 8

| Property | Value |
|---|---|
| Refractive index | 2.7 |
| Relative tint reducing power | 1900 |
| Oil absorption [g/100 g pigment] | 21 |
| TiO₂ content [%] | 95.0 |
| Surface treatment | Al₂O₃, organic |
| pH | ~7.0 |
| Moisture when packed [%] | Maximum 0.5 |
| Crystal size (mean) [nm] | ~220 |
| Specific gravity [g/cm³] | 4.0 |
| Bulk density [g/cm³] | 800 |
| Bulk density (tamped) [g/cm³] | 1000 |

To distinguish titanium dioxide useful in practicing the present invention from other less preferred titanium dioxides, titanium dioxide useful in practicing the present invention is rutile with a surface treatment of Al₂O₃, nitrogen or manganese doping, and a crystal particle size from about 10 nm to about 500 nm verified for example by SEM photography. Dispersing was tested in 95% w/w calcium carbonate base formulation: 5% w/w TiO₂ candidate for mixing and bloom when diluted as a 4% solution in water for field application. Poor dispersing characteristic renders the titanium dioxide unusable. Stability was determined as follows: mixed samples of dispersed titanium dioxide samples were stored at 112° F. for two weeks and checked for hard pack and polymerization. Stable samples resulted in no hard pack or excessive bleed layer.

Other suitable titanium dioxides are listed in Table 9 below:

TABLE 9

| | | Oven | Pass for |
|---|---|---|---|
| TiO₂ | Dispersing | Stability | Chloroplast Effect |
| CCR200Mn | Good | Stable | Yes |
| 400WP | Good | Stable | Yes |
| RDI-S | Good | Stable | Yes |
| 550 | Good | Stable | Yes |

According to the results described herein, it is preferable for TiO₂ particle size to have a distribution of from about 10 nm-about 500 nm.

Photocatalysis is a third mechanism to increase CO₂ sequestration, in addition to light scattering/diffraction and inhibition of chloroplast movement. With absorption of blue and near UV light, and thereby providing inhibition of movement by foliar chloroplasts, foliar TiO₂ nanoparticles store the absorbed electromagnetic (EM) energy. This stored energy can then become an energy source for photocatalysis. Photocatalysis occurs when absorbed and stored EM energy enables a chemical reaction which would otherwise not occur; and the photocatalyzing particle then returns to its original state. Photocatalysis by TiO₂ nanoparticles occurs because these particles are semiconducting nanocrystals (Yan Wang, et. al., Nanoscale Res. Lett., 11:529, 2016).

Photocatalytic processes are described for example in Liu, C. et. al., Frontiers in Plant Science 8:489, 2017. For a given plant species, the benefit of TiO₂ photocatalysis is dependent upon plant physiology and plant health. Plant physiology and plant health are not critical to the increase in CO₂ sequestration provided by foliar light scattering/diffraction and inhibition of foliar chloroplast movement, which are equally effective for a wide variety of plant species. Without being bound by a specific mechanism, photocatalytic benefits are achieved by use of foliar TiO₂ compositions as disclosed herein.

Wherein the titanium dioxide particle size parameters are limited, the CaCO₃ can have a wider particle size distribution. To distinguish calcium carbonate useful in practicing the present invention from other less preferred calcium carbonates, calcium carbonate useful in practicing the present invention has a particle size ranging from about 200 nm to about 3 microns verified, for example, by SEM photography.

A suitable source of calcium carbonate is Imasco Minerals, Inc. (Surrey, BC, Canada). Another suitable source is Specialty Minerals (Lucerne Valley, Calif., USA), products including Vicron® fine ground calcium carbonate, and VICALity™ Extra Light USP/FCC Precipitated Calcium Carbonate. If precipitated calcium carbonate is used, it can be advantageous to include calcite in an amount of 10%-50% of the composition, by weight.

Other sources include Graymont Minerals (Richmond, BC, Canada) and Omya (Oftringen, Switzerland). The content is limestone (CAS 1317-65-3) at a concentration of over 99.9% (% w/w) and crystalline silica, quartz (CAS 14808-60-7), an impurity present at less than 0.1% concentration (% w/w). The product is available at a range of sizes (200X, 3HX, 4HX, 6HX, 7HX, and 11HX). Without being limited to a particular product, the 11HX product is used in compositions disclosed herein.

The 11HX CaCO₃ has the following characteristics: dry brightness: 95; specific gravity: 2.7; bulk density, loose: 0.50 g/cc (31 lb/cu. ft.); bulk density, packed:

0.70 g/cc (44 lb/cu. ft.); Mohs hardness: 3.0; particle shape: crystalline rhombohedron; moisture content: <0.2%.

For preferred ECCS formulations containing calcium carbonate, a surfactant package is chosen to well-disperse the particles to ensure even distribution (anti-agglomeration of calcite and rutile titanium dioxide). This distribution in combination with size of both particles is important for expanded band width absorption to effect the foliar chloroplast light avoidance.

A preferred flowable agricultural calcium carbonate product for use with TiO₂ may be CCCDGF or CCCWGF, which use separate surfactant chemistry. CCCDGF successfully utilizes soy lecithin and Dispersogen PCE. CCCWGF successfully utilizes Ethox Esperse 366 and Silicone PMX Series. Dispersogen PCE is an ether carboxylate, and Ethox Esperse 366 is an alkyl ethoxylate.

Plants that are suitable for application of the materials disclosed herein include agricultural plants, ornamental plants, small and large-scale woods and forests, grasses, and other landscape plants. The data obtained with specific plants described herein is exemplary and not intended to be limiting in terms of applicability of the compositions and methods generally.

The disclosed materials and methods are consistent with and promote goals of the Paris Agreement by fulfilling carbon reduction schemes, cap and trade programs, carbon credits via carbon offset and capture, while increasing food production. The disclosure utilizes the earth's current biomass for Carbon Capture, Utilization & Storage (CCUS) with no change to existing global infrastructure. The disclosed methods are suitable for providing governments, businesses and individuals the opportunity to balance their carbon footprint through the reduction of greenhouse gases.

The carbon dioxide (CO₂) concentration in the atmosphere is now close to 400 ppm, which is significantly higher than the pre-industrial level of about 300 ppm. US Department of Energy (USDE) tests showed 386-388 ppm in 2010. The global mean CO₂ concentration is currently rising at approximately 2+ppm/year.

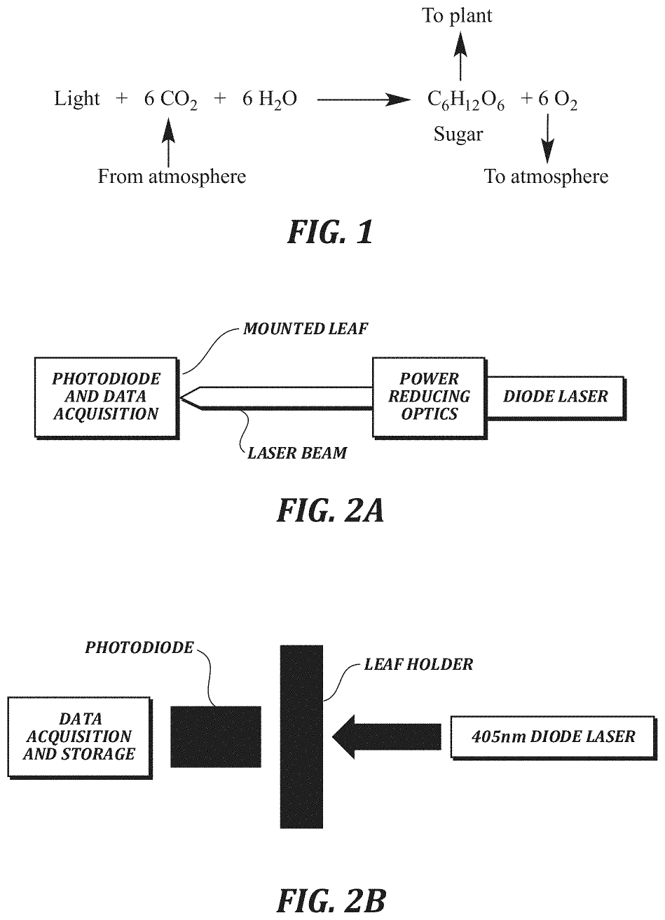

As shown in FIG. 1, photosynthesis is the process by which photosynthetic plants utilize light to build carbohydrates and other organic molecules from carbon dioxide (CO₂) and water (H₂O). Photosynthesis is the mechanism to capture carbon utilized by plants, and the actual mass of carbon captured and sequestered by tree roots, forest mass and agricultural crops is in the trillions of tons. Additionally, carbon absorbed from the air makes up 45-50% of plant dry weight. By daily upregulating of both photosynthesis and carbon draw by the plants, there is continual use of atmospheric CO₂ to make up the 45-50% carbon in plant mass/weight.

This disclosure accordingly provides a new approach for enhancing CO₂ trapping (carbon capture) from the air while naturally increasing the oxygen in the atmosphere and diluting the concentration of greenhouse gasses. The action of ECCS reflects 5% of the direct sunlight back to the atmosphere, naturally reducing excess heat to the plant and earth surfaces. The cyclic action consequently promotes more photosynthesis and water use efficiency of plants.

For the purpose of calculating the efficacy of ECCS compositions for upregulating the photosynthetic process, it should be noted the actual plant use of carbon is 45-50 times greater than the 1% use for chlorophyll. It can be shown by a series of projected calculations (Examples 2 and 3) that upregulating photosynthesis relates to biomass yield increase.

The Earth's atmospheric weight is 5.5 quadrillion tons and percentages of elements are as follows, based on pre-industrial atmosphere composition (approx.) as shown in Table 10. Returning the oxygen and carbon dioxide levels to closer to pre-industrial percentages remains a goal of any technology aimed at reducing greenhouse gases.

TABLE 10

| Component | Symbol | Volume |
|---|---|---|
| Nitrogen | N₂ | 78.084% |
| Oxygen | O₂ | 20.947% |
| Argon | Ar | 0.934% |
| Carbon | CO₂ | 0.033% |
| Dioxide | | |

In summary, the ECCS compositions help inhibit the light avoidance movement by foliar chloroplasts. In one embodiment, the procedure involves applying, such as spraying, the ECCS formulation onto leaves and stems of crops by using commonly known agricultural application techniques. Crop responses to increased carbon capture include increased biomass accumulation, increased yield, improved water use efficiency and increased oxygen (O₂) in the air, which dilutes the concentration of greenhouse gases.

The increase in diffraction/scattering of light increases the participation in photosynthesis by foliar chlorophyll chromophores. The specific formula of ECCS results in absorption of blue and near UV light.

Visual observations and scanning electron microscope images can be used to verify foliar chloroplast light avoidance movement. Exposure of a thin leaf to laser light for a sufficiently long time yields visual evidence of light avoidance movement by foliar chloroplasts. When a leaf thus exposed is removed from the leaf holder, a lighter green color is observed at the exposed area of the leaf. The decrease of green color within the exposed area is due to a decrease in absorption of light, in the exposed area, by chlorophyll chromophores. The decreased absorption by chromophores is due to the fact that a significant fraction of foliar chloroplasts have been hidden by the foliar chloroplast light avoidance movement.

Using the experimental apparatus shown in FIG. 2, the exposure time required for visual observation of the foliar chloroplast light avoidance movement ranges from a few minutes to approximately one hour, with the exact time being determined by leaf thickness and other factors that vary with leaf type and laser power. It is noteworthy that, within approximately thirty minutes, the exposed area of a leaf returns to its original color, which indicates that the laser exposure has not damaged the leaf.

Additional verification of the light avoidance movement by foliar chloroplasts is obtained from scanning electron microscope (SEM) images of selected cross sections of unexposed leaves and leaves exposed to the 405 nm laser beam. Typical SEM images for cross sections from untreated and treated leaves are shown in FIGS. 3B and 3C, respectively.

This disclosure also relates to enhancing strong diffraction which provides excitation of a much larger fraction of available chlorophyll chromophores than does direct sunlight, and the resulting increase in photosynthesis is a significant benefit. (U.S. Pat. No. 9,185,848). As described in the Examples, the method of this disclosure increases a plant's photosynthetic capacity by foliar chloroplast strong light avoidance movement.

Chlorophyll production and the increases resulting from the disclosed treatment can be measured using known methods, for example as disclosed in Gitelson A. A., et al., “The Chlorophyll Fluorescence Ratio F735/F700 as an Accurate Measure of Chlorophyll Content in Plants,” Remote Sens. Enviro. 69:296-302 (1999). Chlorophyll meters are available commercially, for example from Optisciences, Inc., Hudson, N.H. 03051, USA. The CCM-300 meter is suitable for small leaves and conifer needles, and the CCM-200 plus meter is suitable for medium size and larger leaves.

This technology is based on chlorophyll absorption of a blue fluorescence excitation light, and emission of a range of fluorescing light at longer wavelengths. By comparing the ratio of fluorescence emission at 735 nm and at 700 nm, there is a linear response to chlorophyll content in a range from 41 mg m⁻² to 675 mg m⁻². This method does not compare transmission through a leaf at two different wavelengths, so thick samples can be measured. In addition, the fluorescence is measured on the same side of the sample as the excitation light. For these reasons, fluorescence is a suitable method of measurement for leaves smaller than the measuring aperture like immature rice and turf grasses, and samples with curved surfaces like white pine needles.

The flowable agricultural formulas of the disclosure can be administered once or more during a growing season, with coverage of at least 15%, at least 50%, or up to 100% of the surface of the plant leaves and stems, and any percentage range between. The percent coverage can be determined by the degree to which enhanced photosynthesis is desired for a particular plant.

For conifers, a single application is expected to be sufficient. Other plants may require reapplication, for example once every four weeks approximately, to cover new lateral growth and new vertical growth. Such determinations are within the skill of the art, using existing knowledge of plant growth rates, and adjusted as needed based on the rate of growth in a particular season, depending on amount of sunlight and other parameters.

Reapplication following rain, wind and other weather conditions is not expected to be required, in view of the ability of the particles in formula to closely coat the leaf surfaces.

Oxalis, Nasturtium, five species of trees, and two vegetable species are used as test species in these Examples, but the methods and compositions are not limited to these species.

The disclosure also provides a new method to evaluate sun creams (sunscreens) for human use for UV protection. In the experiment shown in FIG. 6, Neutrogena® sunscreen SPF (NSS45) was tested undiluted for its ability to reduce chloroplast movement within Oxalis leaves. The treatment yielded a reduction factor of 0.43. This system of measuring the effect of a leaf treatment on chloroplast movement that otherwise occurs in the presence of sunlight can therefore be useful in testing and comparing the sunscreen potential of other compositions.

Increasing Winter Chill Accumulation and Dormancy Response

For most deciduous fruit and nut trees, shrubs, and vines to break dormancy and begin flowering in the spring, they must first be exposed to chilling temperatures for a sufficient period of time each winter. Deciduous trees become dormant in the fall to protect themselves from winter freezing and make metabolic changes through chilling so they can flower and fruit in the spring.

There are two stages of chilling. The first stage is reversible: as the season starts to cool down, the plant prepares for its period of dormancy. If the temperature warms up for a few days or a week or so, then the plant retreats from its dormancy preparation. In contrast, the second stage is irreversible. At a certain point, a plant or tree has committed itself to dormancy—referred to as endodormancy. Even if the temperature increases again, the tree or plant will remain dormant until other triggers cause it to break dormancy. If the temperatures are low enough for long enough throughout the winter, then the tree or plant will be able to blossom well in the spring, This translates to an effective amount of chilling hours.

The chilling hours do not need to be consecutive, but cumulative. In general, every hour between 32° and 60° F. equals one chill hour received, though the best chilling seems to be up to 45° F., and for every hour above 60° F., either one chill hour is subtracted from the total accumulated in some models or it inhibits chill accumulation in the Dynamic Chill Portions Model. There is no specific day on which the initiation of irreversible chill in the fall can be recorded, or in the spring when chill is no longer of significance. Generally, in the Northern hemisphere, these hours are from November through February or March.

A lack of sufficient chilling can result in little or possibly no flowering and fruit-set, and also results in quality issues such as off-colored or soft fruit. If the temperatures rise too high for too long, such as during an uncommon warm spell in the late winter, then a tree or plant will wake from dormancy and the swelling buds will lose their cold protection. When temperatures drop again, the new growth may be damaged or killed. Crops can be seriously diminished or fail entirely as a result of such a warm spell that breaks dormancy prematurely. This can have serious consequences for the local and national economy, for farmers and growers, and for consumers.

It is therefore a goal of the present disclosure to improve chilling hours during dormancy and to protect buds, stems and bark from winter harm by reducing excessive heating and preventing a premature break from dormancy. These processes are improved by the use of the calcium carbonate/TiO₂ formulations disclosure herein.

Trees of all kinds become heat sinks by absorbing the sunlight striking them, regardless of the air temperature. The earth-colored bark and stems absorb the complete spectrum of light. This can cause sunlit bark temperatures to rise well above 60° F. even when air temperature is below freezing. The greater the trunk and branch diameter, the slower the cool down is after this heating occurs.

This process happens repeatedly in the fall and winter. These temperature swings can harm the bark, reduce chilling hours and trigger early breaking of dormancy. The disclosed formulations can help reduce the effect of such temperature variations.

Other benefits can include better ripening of wood and buds in the fall, rendering them less susceptible to cold injury; reducing bark injury caused by high trunk temperature followed by rapid cooling; reducing maximum cambium temperature; preventing trees from excessive heating during occasional long periods of sunny and warmer winter days, thus opposing premature bud swell and loss of freeze protection; promoting higher proportion of flowers with perfect essential organs; and more even bloom and thus better fruit set.

In the past fifty years, central California, a globally major producer of fruit and nut crops, has seen a 20% reduction in chilling hours and the decline is expected to continue. Similar reductions are seen in other locations where these crops are grown. A connection between the low chill accumulation and poor performance in spring bud break, bloom, and fruit set is well documented in the art.

The chill accumulation requirements vary greatly even within a species as seen in Table 11.

TABLE 11

| Tree, Shrub | |
|---|---|
| or Vine Crop | Chilling Hours |
| Almond | 400-700 |
| Apricot | 350-1,000 |
| Cherry | 600-1,400 |
| Grape | 100-500 |
| Pear | 600-1,500 |
| Peach | 200-1,200 |
| Pistachio | 800-1,000 |
| Plum | 700-1,800 |
| Walnut | 400-1,500 |
| Apple | 400-1,000 |
| | (low chill varieties |
| | require less) |
| Blackberry | 200-500 |
| Blueberry (Northern) | 800 |
| Chestnut | 400-500 |
| Currant | 800-1,000 |
| Fig | 100-200 |
| Filbert | 800 |
| Gooseberry | 800-1,000 |
| Kiwi | 600-800 |
| Mulberry | 400 |
| Persimmon | 200-400 |
| Plum Cot | 400 |
| Pomegranate | 100-200 |
| Quince | 300-500 |
| Strawberry | 200-300 |
| Raspberry | 700-800 |

Planting lower chill varieties of these crops is one long-term solution but only a partial solution. Problems can arise in the late winter because lower chill requirement varieties tend to come out of dormancy more easily. This increases the danger of damage by a late winter freeze.

Over the winter dormancy period, essential metabolic transformations take place in the buds of fruit trees and vines to prepare for the coming fruiting season. In locations which tend to have many sunny winter days, more chill accumulation and better metabolic transformation was achieved in preliminary studies using two or three timely applications of a flowable micronized dispersion of calcium carbonate.

Without being bound by a specific mechanism, the reason for this appeared to be two-fold. (1) Diffusing the light on sunny days keeps the buds and stems cooler, effectively improving the chill accumulation; and (2) limiting the increases in tissue temperature conserves plant energy needed for spring bud break. These timely sprays of calcium carbonate resulted in 25% increases in production, even in good chilling years.

The calcium carbonate dispersion modifies light by breaking apart the light rays as they pass through the calcium crystals. At the very least, the light intensity is split in half and more often passing through multiple crystals makes the light even softer on the plant tissues; in effect, less intensity leads to less heating. Additionally, the calcium carbonate dispersion only absorbs 4% of the light and does not retain heat.

Clay products as previously used are less suitable for reducing the temperature in the way accomplished with calcium carbonate dispersion. Reflective kaolin and related highly reflective clays also absorb high percentages of light which converts to heat and can be difficult to dissipate. Secondly, clays are applied thickly which can interfere with other spray programs and possibly interfere with certain wavelengths of light which would have unexpected results.

A preliminary study was performed to evaluate the chilling effect on Kerman Pistachios using a flowable micronized dispersion of calcium carbonate (Diffusion®, Wilbur-Ellis, Aurora, Colo.). The orchard was divided into sections; two were treated with Diffusion® and one was left untreated. Thermocouples with data recorders were place in the orchard: one air, two controls inserted into buds, and three inserted into buds for the treatment. Each data recorder collected a temperature every five minutes.

For placement of thermocouples in order to detect an effect of treatment, it is preferable to select buds that are on the south side of the tree or plant, facing horizontal or upwards and well exposed to the sun. The measurement of a temperature effect of the selected treatment, or control, is most practically performed using parts of the tree or plant receiving sunlight, in contrast to areas that are shaded and protected from heat fluctuations.

The air temperatures generally increased until the second week of February, with many early February days reaching around 80° F. The night temperatures ranged from the 30's and low 40's, helping to increase the chilling hours.

The temperature data was obtained between January 18 to February 13. The average air temperature showed a general increase during the data period. The treatment was effective to keep stems and buds cooler. The control buds showed an average daytime increase of 5° F. above the air temperature during the time of the trial, thus using 65° F. bud temperature as the upper limit for chilling (60° F. of the air+5° F. the normal increase of sunny day control bud temperatures) showed that there was a total (theoretical) treated chilling hours increase of 3% for the entire data time, and a reduction by 12% of the time when the stems and buds were above 65° F. compared to the control.

Additionally, daytime analysis between 9 a.m. and 4:30 p.m. showed a 37% average decrease in bud heating of the treated compared to the untreated which is expected to help conserve carbohydrate in the buds and stems for the spring. The treatment was calculated to have added several chill portions during the time of the test for a total of 10 to 13 portions compared to only 9 of the untreated. This resulted in a 20% increase in the harvest as shown in the following Table 12.

TABLE 12

| | | Edible, | | Change from |
|---|---|---|---|---|
| Treatment | Acres | pounds | Pounds/Acre | control |
| Control | 11.5 | 32,555 | 2,830.9 | |
| Calcium | 69 | 234,763 | 3,402.4 | +571 |
| Carbonate | | | | pounds/acre = |
| (Diffusion ®) | | | | 20% increase |

Based on this and other preliminary studies, the CaCO₃/TiO₂ formulations of the disclosure are suitable for promoting dormancy and chilling, resulting in commercial benefits to growers and consumers. The challenge of meeting chilling requirements for several crops in California in particular is of ongoing interest to growers. It has been a risk ever since vast acreages of high chilling hour requirement crops were established. Up until recently, the payoff has exceeded the risk involved, but this equation is being altered as a result of climate change and a variety of human factors.

Luedeling, E. et al. “Climatic Changes Lead to Declining Winter Chill for Fruit and Nut Trees in California during 1950-2009”, PLoS ONE 4:e6166 (2009) provides evidence of a steady decline in chilling hours due to a general increase in population and reduction in winter fog which had accounted for many chilling hours. This threatens the viability of several fruit and nut crops. If they are to remain commercially viable, a solution must be found which covers the current investment as well as help future expansion.

Increased air temperatures and the lack of cloud cover (such as fog) exacerbate the problem by raising plant tissue temperatures well above the air temperatures. Reducing air temperature is not a possibility, but simulating the benefits of a cloud cover is possible using calcium carbonate/titanium dioxide compositions disclosed herein with further benefits and uses beyond the crops of the central valley of California.

A delay in bud break by a week is equivalent to approximately 80 to 100 more hours of chilling, or 3 to 5 chill portions depending upon the day and night temperatures for that week. This additional 5% to 10% chilling for a tree would have significant positive benefit in terms of the eventual crop success.

Results of Insufficient Chilling

Failure to achieve required chilling affects all crops that need dormancy. In general, a lack of coordination in vegetative and reproductive bud break occurs, which leads to uneven bloom with a variety of anatomical abnormalities. These include absence of pistils, atrophied ovules, and immature pollen. The net result is poor fruit set and a poor harvest. Long term lack of fulfillment in chilling requirements can lead to plant health decline and eventually, total loss of productivity.

Specific results of insufficient chilling include:

1. Delayed foliation. A tree may have a small tuft of leaves near the tips of the stems and be devoid of leaves for 12 to 20 inches below the tips. Lower buds may break eventually but full foliation is significantly delayed, and the tree is weakened.

2. Reduced fruit set and yield. Flowering in response to insufficient chilling often follows the pattern seen with leaf development. Bloom is delayed, extended, and due to abnormalities in pistil and pollen development, fruit set is reduced. Also, lack of synchronization between opening of male and female flowers leads to delayed or insufficient pollination and reduced yield.

3. Reduced fruit quality. The effects on leaf growth and fruit set are dramatic, but the effects of insufficient chill on fruit quality are subtle, and can occur when other symptoms of insufficient chilling are not evident.

While chilling hours can vary widely year to year, recent studies indicate that average chilling hours in California's central valley have decreased by more than 20% since 1950, and in any given year, chilling hours can be 15% less than the mean. The typical period of chill accumulation in this area is from late November to late February. Part of the problem has been the lack of fog; at other times, winter onset is delayed, and the temperature stays warm well into December.

In addition, warm periods can occur in January or February causing buds to prematurely swell and use up energy. If warming periods last too long, the buds can break, prematurely shortening dormancy and then risk being damaged by freezing later in winter. This has been a long-term problem across the southern portion of the United States and in other countries.

For measuring chilling, there is no universal agreement in the art as to what constitutes chilling hours, or when and how they need to be acquired; in addition, local microclimates preclude generalizing. Chilling is typically measured in terms of cumulative number of hours between 0° C. (32° F.) and 15° C. (59° F.) each winter. Some models, such as the Utah Model, put a percentage to chilling hour effectiveness depending on the temperature and also includes a negative chilling when over 15.5° C. (60° F.). The Dynamic Chill Portions Model measurement begins in September using complex equations to account for chill effectiveness at different temperatures. Regardless of the model, meaningful results can be achieved by consistent data analysis within a given study or field trial.

There is consensus in the art that temperatures much below freezing or above 15.5° C. (60° F.) are not effective for chilling accumulation. The crucial measure involves observing what happens after the leaves have fallen off, until bud break in the spring. This involves a threefold determination. First, observations are made after leaf drop until bud swell; second, hours the temperature is between 0° C. (32° F.) and 15.5° C. (60° F.) counted as chilling; and third, measuring effectiveness. Above 15.5° C. (60° F.) is seen as detrimental for chilling. Overall percentage changes at these times and in these ranges can be applied to the Dynamic Chill Portions Model for comparisons of effectiveness as well since this is a commonly used measurement.

However, because the problem involves both warmer temperatures and the lack of cloud cover, the traditional chill models do not adequately describe all the chilling needs. Air temperature below 15.5° C. (60° F.) does not necessarily mean that the bark, stems, or buds are that temperature. On sunny days these plant parts can be much warmer, as much as 10° C. (18° F.) warmer. During phases of consistently high bud temperatures, the plant can use up stored carbohydrates that are needed for bud break.

Importantly, on cloudy days, air and bud temperatures are close in value. One goal of the treatment protocols disclosed herein is to simulate a cloud cover with a calcium carbonate/titanium dioxide composition of the disclosure: if the temperature of treated buds remains closer to the air temperature on sunny days, better chilling occurs. Proof-of-principle experimentation involved comparing air, control bud, and treated bud temperatures using thermocouple wires inserted into buds connected to battery operated data collectors placed in plastic bags for protection.

Testing with calcium carbonate dispersion (Diffusion®) was performed on azaleas to determine if bud temperatures could be suppressed with a practical amount of spray and applied with standard equipment. Further tests were performed on cherry trees near Maricopa, Calif. The results showed general visual improvement in bloom, fruit set and leaf out. These parameters have been negatively affected by less chilling.

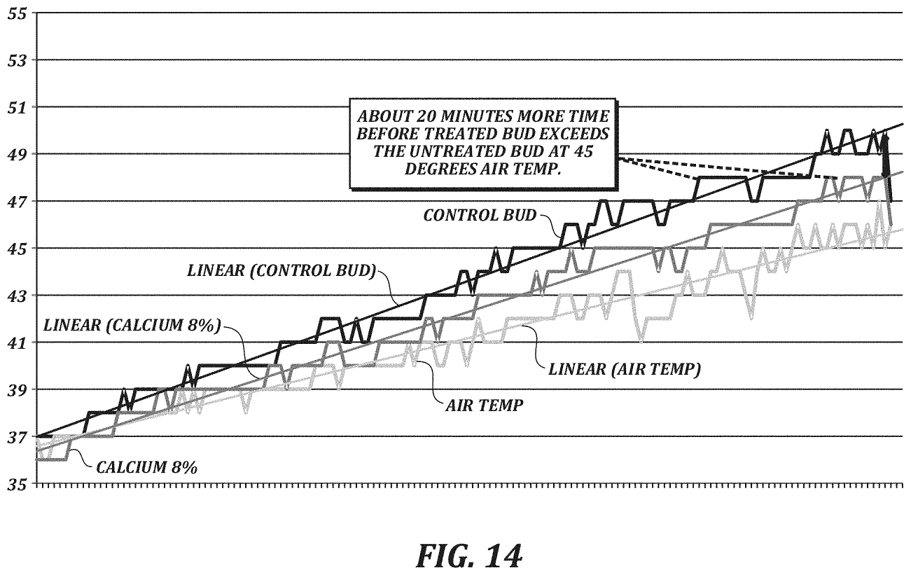

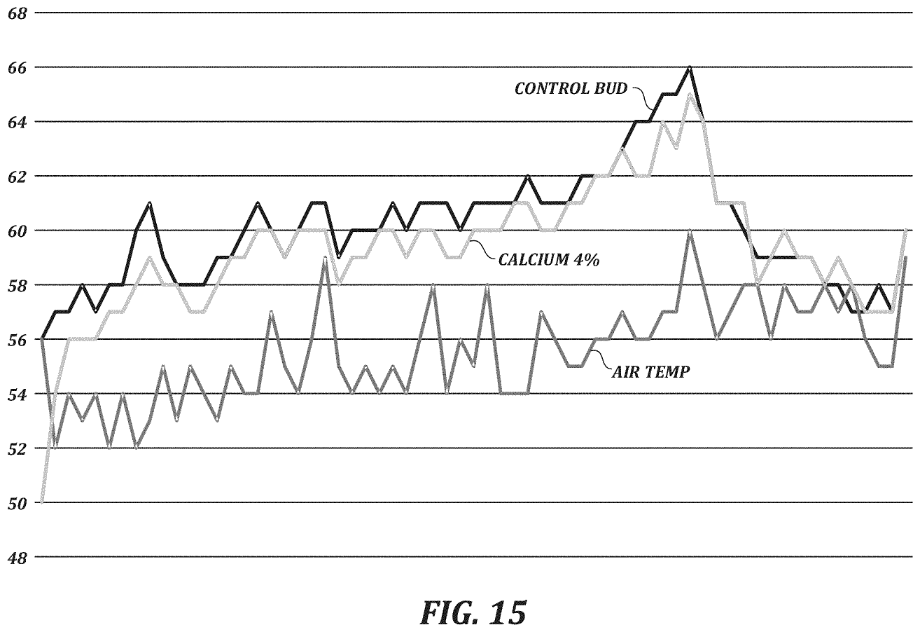

In azalea shrubs, the calcium carbonate diffusion spray was shown to be both practical and able to keep the daytime bud temperatures close to the air temperature as seen in FIGS. 14 and 15, which illustrate results from azalea tests.

Additional tests were performed on pistachios with thermocouples placed in several orchards. The CaCO₃ treatment showed 13% to 19% more chilling hours and 28% to 40% less time at temperatures detrimental to chill accumulation. In chill portions, it appeared that 15% more could be acquired by treatments. The effect was more even bloom (both male and female) and better nut set. This resulted in an 18% to 25% increase in harvest.

In the tests with thermocouples, they are placed underneath the buds into the stem cortex thus they are equivalent to internal bark temperatures. With applications of the disclosed formulation in the tests described herein, there were reductions of 7% to 39% and 7% to 41% in keeping the bark temperatures below 70° F. and 75° F. respectively compared to the untreated control.

Further trials with Diffusion® calcium carbonate were conducted on pistachios and cherries, as well as on almonds, nectarines, pomegranates, and grapes. The results were also positive; because the buds experienced increased chilling and less time at detrimental temperatures, there was more even bloom, better fruit and nut set, which resulted in more even maturation, less picks or shakes, and better quality and volume of harvest. These benefits were even observed during a good chill year for central California, where the crops were grown.

Close harvest records for pistachios were maintained in four locations representing about 600 acres. The yield represented between 12% and 27% increase in pounds of In Shell Splits (highest payment) with an average decrease of 2% in Kernels (the lower payment, down from 11% of the total payment to 9%), and had a 22% dollar income increase. Another harvest record showed a 32% increase in harvested volume, with most of the crop coming off on the first shake.

For table grapes, most of one crop was ready at the first pick. In cherries, a much larger fruit set and fruit size with earlier and more even maturation was found. Even though pomegranates require only 100-200 chill hours, a harvest reported more even bloom, better fruit set and larger harvest.

Without being bound by a specific mechanism, the premise of simulating a cloud cover on the buds by application of calcium carbonate diffusion is effective to improve chill accumulation and the dormancy response to adequate chilling. Scattering the light as it passes through the crystalline structure reduces the intensity and softens the light striking the plant tissue, limiting the temperature increases and reducing the time at detrimental levels for chill accumulation on sunny winter days.

This result effectively increases the chill accumulation, prevents premature bud swell, and lowers the consumption of stored energy needed for spring bud break. This leads to more even bud break (both flowers and vegetation), and better fruit and nut set, which in turn yields increased quality, volume and value of harvest. The treatment also is effective on low chill requirement crops like pomegranate and grapes. Because winter applications are also effective in good chill years, trees and vines can benefit from the lower tissue temperatures every year helping them to remain healthy and profitable where sunny winters commonly occur.

11HX calcium carbonate treatment was effective in maintain dormancy in a cherry crop. The content of 11HX is limestone (CAS 1317-65-3) at a concentration of over 99.9% (% w/w) and crystalline silica, quartz (CAS 14808-60-7), an impurity present at less than 0.1% concentration (% w/w). The product is available at a range of sizes (200X, 3HX, 4HX, 6HX, 7HX, and 11 HX, for example from Graymont Minerals (Richmond, BC, Canada) and Omya, Oftringen, Switzerland). Two sweet cherry orchards were selected about six miles apart and about thirty miles south of a point used for general climatic data. Two types of calcium carbonate were initially tested: a courser 4HX on 56 acres at 5 gallons per 100 gallons of water, and micro grind 11HX on 6 acres at the same rate. The first spray was done with most of the leaves in place.

For the 4HX there was no difference from the control buds. The finer 11HX product gave better light dispersion and thus more cooling. Temperature was measured, and indicated on a day-to-day basis which days were sunny and which were cloudy. On sunny days, the bud temperatures increased rapidly. On one day which was primarily sunny with an occasional cloud, the 11HX-treated buds were several degrees colder than the untreated buds.

Two months after the initial application, the 11HX calcium carbonate continued to have an effect on lowering bud temperature compared to controls. The high and low temperatures slowly crept upward until the first 70° F. daytime temperatures began. Of note is how quickly the bud temperature rose each day from the 30's to the 70's. The daytime difference between the air temperature and the control often exceeded 10° F. with the 11HX treated temperatures lower than control, but higher than air temperature.

The chilling for this crop was basically over when the buds began to swell and flowers appeared on the untreated trees. Of note, this occurred a few days earlier in the control trees than on the 11HX-treated trees. General visual improvement in bloom, leafing out, fruit-set and health were also noted for the 11HX-treated trees.

The temperature probes for the 11HX-treated trees continued to be cooler for a few weeks longer. This provided evidence that the 11HX treatment was effective for at least six weeks and possibly longer depending on the weather.

Application of the calcium carbonate/TiO₂ compositions of the disclosure can be performed with standard spray equipment at regular winter spray speeds. Fifty percent coverage (the top half of stems) is adequate to see desired results. One preferred timing schedule for the first application is after leaf drop and (optionally) the first winter fungicides/insecticides have been applied, followed by a second 4 to 6 weeks later and when it is expected to be dry for three days afterwards and above freezing (5° C./41° F. or higher) while applying.

The rate of about 4 gallons per acre in 100 gallons of water is suitable, and up to about 6 gallons, particularly if weather conditions would preclude a second spray on. Tree applications can be used at 4 gallons per acre every 4 to 6 weeks if two are not enough to keep the crop well covered until bud break in the spring.

Formulations disclosed herein are suitable for this use, including but not limited to a formulation of wet ground calcium carbonate comprising components selected from the following ranges: Potable water, 8.85-20.85 w/w %; Esperse 366, 0.5-1 w/w %; Titanium dioxide, 0.5-5.0 w/w %; CCCWG at 74% Calcium Carbonate, 78-84 w/w %; Silicone PMX200, 0.1-0.5 w/w %; Mergal K10N, 0-0.25 w/w %; Mergal 186, 0-0.25 w/w %; and Guar Gum, 0.05-0.15 w/w %.

Also suitable is a formulation of dry ground calcium carbonate comprising components selected from the following ranges: Potable water, 25.65-74.35 w/w %; Dispersogen PCE, 0.5-1.0 w/w %; Soy Lecithin, 2.0-3.0 w/w %; Sodium carbonate: 0.2-0.5 w/w %; CCCDG, 58-61.5 w/w %; Alcohol 1.5-3.0 w/w % (ethanol or isopropanol); Clove Oil, 0-0.2 w/w %; Guar Gum 0.05-0.15 w/w %; and Titanium dioxide, 0.5-5 w/w %.

The titanium dioxide can range in size from 10 nm to 50 nm, such as 10 nm, and used at a concentration of 50 ppm-500 ppm, such as 300 ppm. The titanium dioxide can also be used at sizes of 200-250 nm as a blend, and at a concentration of 1% to 5% by weight. These percentages are not intended to exclude additional concentrations that still accomplish the results as contemplated herein. For example a concentration of between 5% and 6%, or above, is also within the scope of the disclosure.

Also suitable for the dormancy aspect of this disclosure is a composition of matter formulated with dry ground calcium carbonate, the composition comprising Potable water, 30.08% w/w %; Dispersogen PCE, 0.95% w/w %; Soy Lecithin, 2.71 w/w %; Sodium carbonate, 0.38 w/w %, CCCDG, 58.43 w/w %; Alcohol, 2.14 w/w % (ethanol or isopropanol); Clove Oil, 0.19 w/w %; Guar Gum, 0.12 w/w %; and Titanium dioxide, 5.00 w/w %, and a composition of matter formulated with wet ground calcium carbonate, the composition comprising Potable water, 14.44 w/w %; Esperse 366, 1.00 w/w %; Titanium dioxide, 5.00 w/w %; CCCWG at 74% Calcium Carbonate, 78.96 w/w %; Silicone PMX200, 0.25 w/w %; Mergal K10N, 0.15 w/w %; Mergal 186, 0.10 w/w %; and Guar Gum, 0.10 w/w %.

Application of the disclosed formulations can also contribute to tree health before and during dormancy by enhancing photosynthesis during this phase. As described by Pfanz, H. et al., Naturwissenschaften 89:147-162 (2002), photosynthesis in tree stems can play a role tissue health by producing oxygen and reducing the internal stem anaerobiosis. Re-fixing the CO₂ produced by respiration and release of O₂ within the stems can maintain a better CO₂ balance and provide extra photosynthates during the dormant phase. Without being bound by a specific mechanism, the disclosed formulations can, as described above for treatment of leaves to enhance photosynthesis, also enhance photosynthesis during the dormant phase of trees, shrubs and vines, particularly on sunny days when there is a reduction in chilling hours.

The disclosure provides a method for reducing bud temperature increases during dormancy of a deciduous plant, comprising treating the plant with a composition comprising nanoparticles of titanium dioxide, nanoparticles of calcium carbonate, at least one surfactant, and water in an amount adequate to provide flowability.

The treatment can be formulated with wet ground calcium carbonate, comprising components selected from the following ranges: Potable water, 8.85-20.85 w/w %; Esperse 366, 0.5-1 w/w %; Titanium dioxide, 0.5-5.0 w/w %; CCCWG at 74% Calcium Carbonate, 78-84 w/w %; Silicone PMX200, 0.1-0.5 w/w %; Mergal K10N, 0-0.25 w/w %; Mergal 186, 0-0.25 w/w %; and Guar Gum, 0.05-0.15 w/w %.

The plant can be selected from the group consisting of but not limited to almond, apricot, cherry, grape, pear, peach, nectarine, pistachio, plum, walnut, apple, blackberry, blueberry, chestnut, currant, fig, filbert, gooseberry, kiwi, mulberry, persimmon, plum cot, pomegranate, quince, strawberry, and raspberry.

The treatment can cover at least 40%, at least 50%, at least 60%, or up to 100% or any intervening percentage value of said plant trunk, stem, branch and bud area.

The treatment can be applied at least once prior to endodormancy, and/or at least once after endodormancy and prior to bud break. The treatment can be applied two, three, or four times after endodormancy and prior to bud break. The number of treatments will be determined by the farmer, grower and/or applicator, with consideration of weather, temperature, amount of rain, amount of fog or cloud cover, and other factors that could affect the duration of the treatment on the plant.

Also provides is a method of increasing winter chill accumulation in a deciduous plant, comprising treating the plant with a composition comprising nanoparticles of titanium dioxide, nanoparticles of calcium carbonate, at least one surfactant, and water in an amount adequate to provide flowability.

The treatment can be formulated with wet ground calcium carbonate, comprising components selected from the following ranges: Potable water, 8.85-20.85 w/w %; Esperse 366, 0.5-1 w/w %; Titanium dioxide, 0.5-5.0 w/w %; CCCWG at 74% Calcium Carbonate, 78-84 w/w %; Silicone PMX200, 0.1-0.5 w/w %; Mergal K10N, 0-0.25 w/w %; Mergal 186, 0-0.25 w/w %; and Guar Gum, 0.05-0.15 w/w %.

The plant can be selected from the group consisting of but not limited to almond, apricot, cherry, grape, pear, peach, nectarine, pistachio, plum, walnut, apple, blackberry, blueberry, chestnut, currant, fig, filbert, gooseberry, kiwi, mulberry, persimmon, plum cot, pomegranate, quince, strawberry, and raspberry.

The treatment can cover at least 40%, at least 50%, at least 60%, or up to 100% or any intervening percentage value of said plant trunk, stem, branch and bud area.

The treatment can be applied at least once prior to endodormancy, and/or at least once after endodormancy and prior to bud break. The treatment can be applied two, three, or four times after endodormancy and prior to bud break. The number of treatments will be determined by the farmer, grower and/or applicator, with consideration of weather, temperature, amount of rain, amount of fog or cloud cover, and other factors that could affect the duration of the treatment on the plant.

The Examples below are included to demonstrate particular embodiments of the disclosure. It should be appreciated by those of ordinary skill in the art that the compositions and techniques disclosed in the Examples represent compositions and techniques found by the inventors to function well in the practice of the disclosure, and thus can be considered to constitute preferred modes for its practice. However, those of ordinary skill in the art should, in light of the present disclosure, appreciate that many changes can be made in the specific particular embodiments which are disclosed and still obtain a like or similar result without departing from the spirit and scope of the disclosure.

### EXAMPLES

### Example 1. Preparation of ECCS Formulation

ECCS is formulated with ultrafine wet or dry ground or precipitated calcium carbonate derived from calcite and titanium dioxide employing a dispersion surfactant package and stabilizers. As discussed in the Detailed Description, calcium carbonate useful in practicing the present invention preferably has a particle size ranging from 200 nm to 3 microns verified, for example, by SEM photography.

Experiments were performed to study the effects of TiO₂ and CaCO₃ formulations on the same leaf surfaces. To study these parameters, a formula ladder study of TiO₂ ranging from 0.1 wt % to 5 wt % was tested with CaCO₃ at 60 wt %. Foliar chloroplast avoidance was noted for all ranges of the rutile surface-treated TiO₂, as compared to the water control test of the same leaf. In this preliminary experiment, the best results were obtained with Cinkaran 220 Mn and Sachtleben RDI-S formulated with 60 wt % CaCO₃. In subsequent experiments other formulations achieved as good or better results.

The foliar chloroplast avoidance movement was the mode of action according to the present Example regardless of the TiO₂ source. Minimal foliar chloroplast avoidance movement was observed using TiO₂ in water alone as shown in FIG. 6. Avoidance movement was at the lowest detectable amount using CaCO₃ in water alone.

### Example 2

This example is on a small scale of one acre and is based on the following premises. (1) An average above ground crop yields 10,000 lb. of spinach/acre. (2) Spinach contains about 1% of chlorophyll (Chi). (3) The average molecular weight of chlorophyll is 881 g/mole. (4) The chlorophyll molecule has 55 carbons. (5) The molecular weight of CO₂ is 44 g/mole. (6) The molecular weight of O₂ is 32 g/mole.

### Calculations for Non-Treated Plants:

1. 10,000 lb. spinach/acre=4,545 kg spinach/acre=45.45 kg Chl/acre
2. 45.45 kg Chl/acre=45,450 g Chl/acre=51.6 mole Chl/acre
3. 51.6 mole Chl/acre=2,838 mole carbon/acre=125 kg CO₂/acre=275 lb. CO₂/acre
4. For each mole of CO₂ taken up, one mole of O₂ is released

Conclusion: 275 lb. CO₂/acre×(32/44)=200 lb. 02/acre, pre-treatment

Benefit of ECCS treatment at twenty percent more chlorophyll synthesized by the plant

### Results:

1. 275 lb. CO₂/acre×0.2=55 lb. more CO₂/acre taken up from the atmosphere
2. 200 lb. 02/acre×0.2=40 lb. more O₂/acre given up to the atmosphere

There are at least 938 million acres of prime agricultural land and forest in the United States. Applying the calculations above to one million acres of prime Douglas Fir mixed canopy forest containing 100 thousand pounds of chlorophyll-producing biomass will yield the following results as shown in Example 3, based on the one acre illustration of spinach in Example 2.

### Example 3

This example is a large scale projection based on one million acres. A Douglas fir forest canopy is 7.5 to 75 times more productive of photosynthesis than spinach; one acre of ECCS-treated Douglas fir forest at 75,000 pounds canopy mass will produce the following results, based on 7.5× compared to spinach:

### Results:

1. 275 lb. CO₂/acre×0.2=55 lb.×7.5=412.5 pounds more CO₂/acre taken up from the atmosphere than by chlorophyll alone.
2. 200 lb. 02/acre×0.2=40 lb.×7.5=300 pounds more 02/acre given up to the atmosphere than by chlorophyll alone.
Extrapolating these results to one million acres of treated Douglas fir provides the following results:
1. 206,250 tons more CO₂/acre taken up from the atmosphere than for chlorophyll alone, and 206,250 tons throughout the year, yielding a 20% increase.
2. 150,000 tons more 02/acre given up to the atmosphere than for chlorophyll alone; 300 tons more oxygen/acre, and up to 450,000 tons oxygen in conifers.
By treating 938 million acres of prime agricultural land and forest in the United States, the following effect on the atmosphere can be achieved:
1. 193,462,500 tons more CO₂ taken up from the atmosphere than for chlorophyll alone.
2. 140,700,000 tons more O₂ given up to the atmosphere than for chlorophyll alone.

These examples are calculated based on one standard application per season of ECCS and are not inclusive of all biotic factors associated with plant growth and reflected light. They also will depend on the composition of a mixed forest, in which a proportion of the trees are deciduous. Carbon absorbed from the air makes up 45-50% of plant dry weight. Photosynthesis is merely the machine to capture carbon utilized by plants, and the actual mass of carbon captured and sequestered by tree roots, forest mass and agricultural crops are in the trillions of tons.

### Example 4. Chlorophyll Levels in Treated and Untreated Trees Including Conifers

Five tree species typically found in Pacific Northwest forests obtained from Brooks Tree Farm (Brooks, Oreg.) were treated with CCCWGFW-TD. The five species are: Douglas Fir, Port Orford Cedar, Noble Fir, Ponderosa Pine and Oak. 25 of each species were used, as second year seedlings in 2-inch containers with slow release fertilizer.

Four trees of each species were matched for size and form, and then planted in 12 inch pots, two trees per pot. One pot of each species was selected for treatment and the other remained non-treated. Treated trees were sprayed with a 4% solution of the formulation of Table 5, then all the 12-inch pots were placed in a sunny location to receive maximum solar radiation.

The trees were watered every few days and evaluated for condition and effect of the spray at Week 1. All trees were healthy, and initially no difference was found between treated and non-treated. Prior to Week 4, growth differences became evident. The treated Douglas Fir was several inches taller and broader than the non-treated. The treated Ponderosa Pine was fuller and darker than the non-treated.

At Week 8, evaluation of the chlorophyll content was performed using Opti-Sciences CCM-300 chlorophyll fluorescence meter which measures the ratio of fluorescence between the 700 and 735 nm wavelengths of light.

Needles were cleaned of dried formula application immediately prior to measurement. For the Douglas Fir, Ponderosa Pine and Noble Fir, a variety of needles were chosen from upper, middle and lower portions of the seedlings and then two readings were taken in each of three locations on each needle: the base, middle and near the end on as much as possible the top (sun facing) portion of the needles. The readings were averaged and then evaluated.

The Port Orford Cedar was measured in multiple locations on each of the seedlings as the needles are branched and not straight as in the other three conifers. The Oaks were beginning to senesce, so only the fully green leaves were chosen and multiple readings from three leaves each were taken on the top sides of the leaves.

The results of the averages in chlorophyll content of the needles and leaves are shown in Table 13 below.

TABLE 13

| | Chlorophyll concentration (mg/m²) | | Percent |
|---|---|---|---|
| Species | Treated | Non-Treated | increase |
| Douglas Fir | 228 | 146 | 56% |
| Noble Fir | 297 | 271 | 9.5% |
| Ponderosa Pine | 314 | 256 | 23% |
| Port Orford Cedar | 196 | 162 | 22% |
| Oak | 527 | 434 | 22% |

In conclusion for the first part of this example, the experimental formulation enhanced both growth and chlorophyll content in all five tree species tested at week 8.

The same trees were treated again in the next years growing season. Treatment was carried out during the second growing season on weeks 1, 3, and 7 using a 3% spray of the formulation shown in Table 5, in which the TiO₂ concentration was 4% of the formulation. As noted in Table 14 below, the Douglas Fir new growth received one treatment. 21 weeks after the initial treatment, the chlorophyll content was measured as described above for the week 8 measurements. The results for the five species are shown in Table 14.

TABLE 14

| | Chlorophyll concentration (mg/m²) | | |
|---|---|---|---|
| | Treated | Non-Treated | |
| | (average of two | (average of two | Percent |
| Species | or more readings) | readings) | increase |
| Douglas Fir | 338, 433, 408, 430 | 243, 259 (251) | 60.3% |
| new growth | (402.25) | | |
| (one treatment | | | |
| at week 7) | | | |
| Douglas fir | 341, 328 (334.5) | 217 | 54.1% |
| old growth | | | |
| Noble Fir | 490, 468 (479) | 398, 423 (410.5) | 16.7% |
| Ponderosa Pine | 490, 531 (510.5) | 370, 417 (393.5) | 29.7% |
| Oak | 385, 398 (391.5) | 351 | 11.5% |
| Cedar | 528, 509, 538 (525) | 414, 465, 465 | 17.2% |
| | | (448) | |

In addition to the increase in chlorophyll in all five species tested as shown in Table 14, treated trees demonstrated more second season new growth than the untreated trees.

### Example 5. Use of a TiO₂ Nanoparticle Foliar Treatment to Inhibit Intercellular Chloroplast Strong Light Avoidance Movement in Peppermint Leaves

In the present Example, the avoidance movement of chloroplasts (CPs) inside leaves of peppermint plants is induced using a 405 nm diode laser beam. Light having a wavelength of 405 nm is absorbed by chlorophyll chromophores and by crystalline TiO₂. The laser beam intensities used in the present work are in the range 2-10 mW/cm². At the 405 nm wavelength, the equatorial midday Sun has an intensity of roughly 10 mW/cm².

In summary, CP avoidance movement was detected visually, by observing a lighter green color on the area of leaf exposure to strong light, and by scanning electron microscopy. The leaves used in the Example were detached from the plant; and they were kept moist at all times. When the CP strong light avoidance movement was observed visually, it was also seen that each leaf returned to its original zero-avoidance state within roughly 30 minutes.

### Experimental Apparatus and Procedure

A schematic diagram of the experimental setup used herein is shown in FIG. 2B. Within the plant leaf holder, a leaf is held with its plane perpendicular to the laser beam, and with its adaxial surface within 1-2 mm of the surface of a 1-cm diameter photodiode having its front surface also perpendicular to the direction of the laser beam. The photocurrent of the photodiode is amplified and digitized and fed into a laptop personal computer. The part of the leaf not within the laser beam is in contact, on both sides, with a distilled water moistened pad. Pads are replaced after use with one leaf.

The apparatus is located in a photographic darkroom, with no windows. With the exception of the laser beam, all lights in the darkroom are weak, and plants exposed to these lights are in the weak-light chloroplast accumulation condition (Agarwal, C. et al., PLOS ONE 8:1-11, 2013). Outside the darkroom, peppermint plants are kept in dark enclosures.

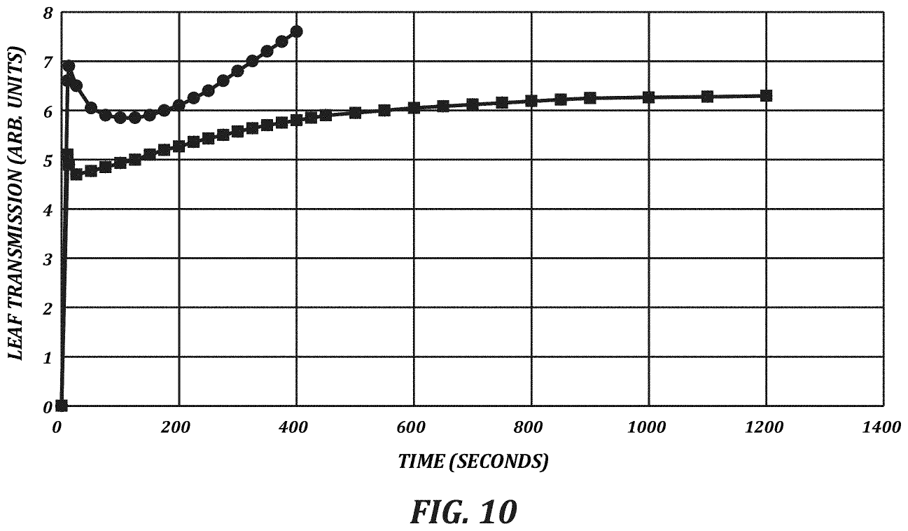

Two representative scans of the temporal variation of leaf transmission of the 405 nm laser beam are shown in FIG. 10. These two sets of data were obtained as follows:

1. A peppermint leaf was placed in the leaf holder and the 1-cm diameter portion of the leaf surface to be illuminated by the laser beam was sprayed with distilled water. For the remainder of the procedure, the leaf remained fixed in place in the leaf holder.

2. The exposed leaf surface was air-dried.

3. With the laser beam on, and blocked, the darkroom lights were turned off, and the temporal scan was initiated. No light from the backlight of the laptop was seen by the photodiode.

4. The temporal scan continued as the laser beam was unblocked. This resulted in the sharp initial rise in leaf transmission for both scans shown in FIG. 10.

5. The upper scan shown in FIG. 10 was for a distilled water treatment. The scan continued for 400 sec.

6. The laser beam was blocked, and the exposed leaf surface was air-brush sprayed with a selected leaf treatment. For the data of the lower scan of FIG. 10, the leaf treatment solution consisted of, by volume, 95% distilled water, a 4% mixture of CaCO₃ nanocrystals together with a surfactant material (lecithin), and 1% TiO₂ nanocrystals. Both types of nanocrystals had an average size dimension of roughly 200 nm.

7. A wait time of 10-20 minutes allowed the leaf treatment to equilibrate, and to provide time for chloroplasts in the leaf area previously exposed to the laser beam to re-accumulate away from cell walls. The weak lights of the laboratory encouraged chloroplast re-accumulation (Agarwal, C. et al., PLOS ONE 8:1-11, 2013).

8. Parts 3, 4, and 5 of the procedure were repeated for the treated leaf. For the data of the lower curve shown in FIG. 10, the total scan time was 1200 seconds.

Results. The principal result of this Example is illustrated by the data shown in FIG. 10. Data points for the upper curve in FIG. 10 are for the initial transmission scan of the leaf. Henceforth, this peppermint leaf is referred to as leaf #1. For this scan, for leaf #1, the exposed area of the leaf has been sprayed with distilled water, and dried.

For the data of the upper curve of FIG. 10, the decrease in transmission occurring in the temporal region 10-100 sec. was probably dominated by an increasing alignment of chlorophyll chromophore transition dipole moments (TDMs) with the polarization direction of the linearly polarized laser light (Bryant, D. A. et al., J. Phys. B—Atomic, Molecular and Optical Physics 51:49, 2018). Prior to their exposure to the laser beam these TDMs were oriented randomly. Increased alignment yielded increased absorption and, therefore, a decrease in transmission of the laser beam through the leaf.

For scan times greater than 100 sec., the increase in transmission for the upper curve of FIG. 10 was due to strong light chloroplast avoidance movement. The straight-line portion of the curve, for times greater than 200 sec., is in agreement with previous results (Wada, M. et al., Methods in Molecular Biology 774:87-102, 2011; Ahmad, S. et al., Current Plant Biology 13:6-15, 2018). In these previous experiments, a linear increase in leaf transmission, due to chloroplast avoidance movement in strong light, occurred for a time period of roughly 600 sec.

For the data of the lower curve of FIG. 10, the transmission peak near the zero of time was lower in value than that for the upper curve because the leaf was treated with CaCO₃ and TiO₂ nanoparticles. The CaCO₃ nanoparticles scattered the incident light of the laser beam, thereby decreasing the measured transmission of the laser light. The leaf transmission was lowered still further by the TiO₂ light absorption at the 405 nm wavelength of the laser.

For the lower curve of FIG. 10, the decrease in transmission occurring in the scan time region 10-40 sec. was probably due mainly to the alignment of chlorophyll chromophore TDMs, as with the data of the upper curve. For scan times greater than 100 sec., the data of lower curve differed markedly from those of the upper curve. There was no straight-line portion of the lower curve, and the transmission curve approached an upper limit of roughly 6.2 (arb. Units).

It is reasonable to assume that the linear portion of the upper curve of FIG. 10 extended to at least 500 sec. Assuming this curve to lose linearity for scan times greater than 500 sec., a transmission limit of roughly 9 (arbitrary units) can be assumed. Thus, for treatment of the leaf with the CaCO₃+TiO₂ nanoparticle solution, the increase in laser light transmission due to chloroplast strong light avoidance movement was smaller by roughly one third than it was when the leaf was treated with distilled water.

For leaf #1, a third transmission scan was taken after the CaCO₃+TiO₂ treatment was “washed off” using distilled water. The wash-off consisted of spray only. Following a 10-20 min. wait time, a third transmission scan of this leaf was done. For this scan, the transmission peak near the zero of scan time had the same transmission value as for the data of the upper curve of FIG. 10. This indicates that, prior to the third leaf scan, a complete chloroplast weak light accumulation had occurred.

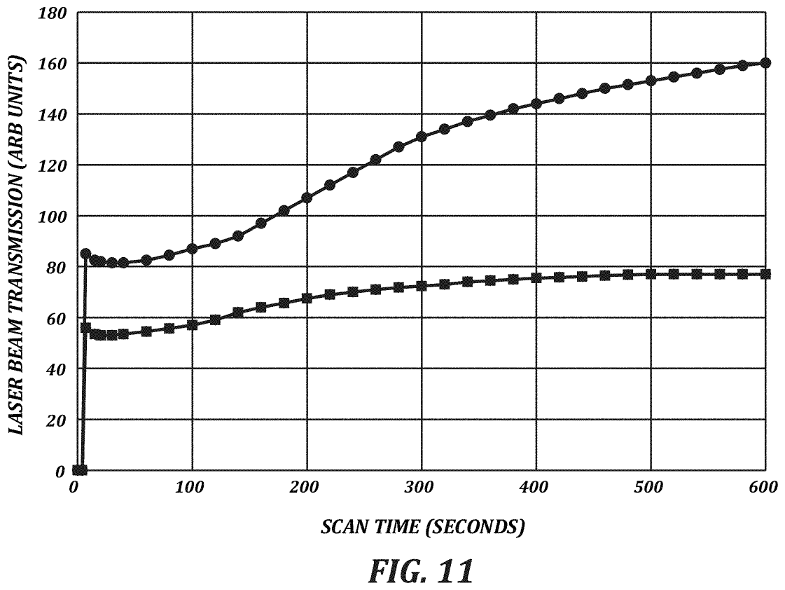

The results of a second set of temporal leaf transmission scans of laser light, for leaf #2, is displayed in FIG. 11. For the data of FIG. 11, the leaf treatments and scan procedures were identical to those for the data of FIG. 10. Henceforth, data for the distilled water treatment is referred to as “bare leaf data”; and, for leaf #2, data resulting from the CaCO₃+TiO₂ nanoparticle solution treatment is referred to as “treated leaf data”. Three differences in the data of FIG. 10 and FIG. 11 are noteworthy:

1. For the temporal leaf transmission scan for the bare leaf (FIG. 11), the scan extended to 600 sec., 200 sec. longer than the same scan for leaf #1.

2. For the data of FIG. 11, all values of leaf transmission are much larger than for the data of FIG. 10. This difference is due to the fact that Leaf #2 is much thinner than Leaf #1.

3. An upper limit of transmission value can be determined for both data sets of FIG. 11. The chloroplast movement inhibition factor (CPMIF) for these two data sets is obtained by subtracting, for each data set, the value of transmission at the transmission minimum occurring in the 25-50 sec. range of scan time from the ultimate maximum value of transmission. Then, CPMIF equals (bare leaf transmission difference)/(treated lea transmission difference) minus 1.

Data sets such as those exemplified in FIGS. 10 and 11 were obtained from 70 peppermint leaves, and the results of these measurements are summarized in Table 15.

TABLE 15

| | Chloroplast | Number |
|---|---|---|
| | movement | of |
| | inhibition | temporal |
| Leaf Treatment | factor | scans |
| CRC058 w/RDI-S (5%) + 300 ppm 5, 10, 20 nm TiO₂ | 9 | 1 |
| CRC058 w/3395 + 3395 (5%) w/150 ppm 10 nm TiO₂ | 2.5 | 1 |
| 11Hx w/lec. (3% sol'n) w/5% RDI-S | 1.6 | 4 |
| CRC058 w/3395 + 3395 (5%) | 1.4 | 2 |
| CRC90 w/RDI-S (5%) w/150 ppm 20 nm TiO₂ | 1.1 | 2 |
| CRC058 w/3395 + RDI-S (5%) + 150 ppm CCR200 (20 nm TiO₂) | 1 | 3 |
| CRC90 w/RDI-S (5%) w/150 ppm 20 nm TiO₂ Dl-S + PCE | 0.5 | 2 |
| RDI-S + 20 nm TiO₂ (5%) | 0.5 | 2 |
| “J” CaCO₃ 11 HX | 0.5 | 1 |
| “g” RDI-S + PCE + 150 ppm 20 nm TiO₂ | 0.3 | 2 |
| 11Hx w/lec. (2% sol'n) | 0.3 | 1 |
| CRC058 + lec. (2%) | 0 | 3 |

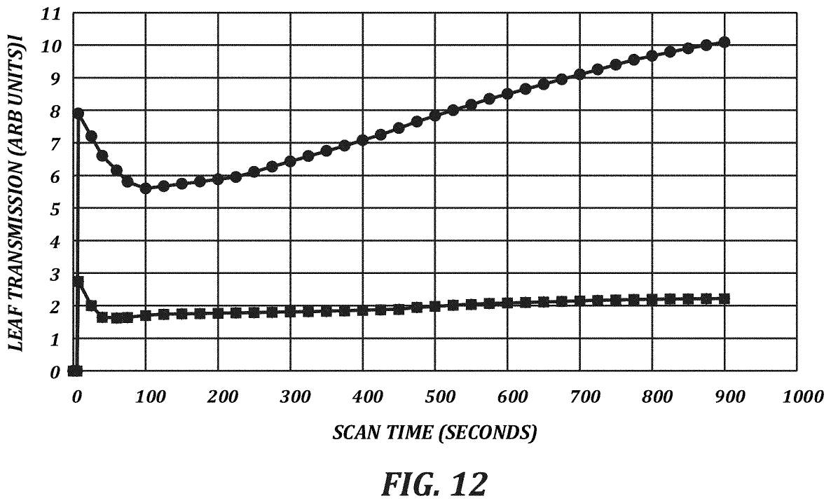

The CPMIF for the first entry in Table 15 is much larger than for any other leaf treatments. The data sets which yielded this large value of CPMIF are shown in FIG. 12. The overall low values of leaf transmission for the treated leaf data set of FIG. 12 is attributed to the relatively large quantity of TiO₂ nanoparticles in this leaf treatment. Thus, the laser light absorbed by TiO₂ nanoparticles is significantly larger than for any of the other leaf treatments listed in Table 15.

In conclusion for this Example, there is a slow-down in chloroplast strong light avoidance movement in TiO₂ nanoparticle-treated leaves. Without being bound by a specific mechanism, the data suggest that this slow-down is dur to photocatalysis by TiO₂ inside the plant leaves. Although TiO₂ achieves an important effect, in practice, a mixed TiO₂+CaCO₃ solution will provide benefits from light scattering by the CaCO₃.

### Example 6. Use of a TiO₂ Nanoparticle Foliar Treatment to Improve Water Use Efficiency in a Variety of Plants Species

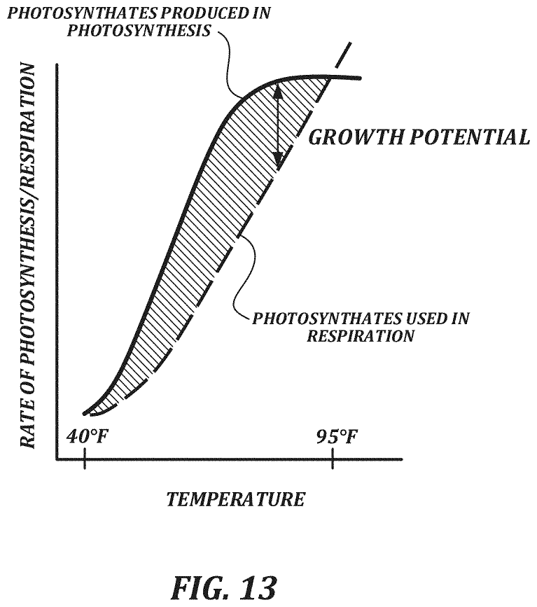

As described in this Example, data were collected over two growing seasons to investigate Water Use Efficiency (WUE) using a continuous method that does not involve the destruction of the crop. The method involves treatment of crops as described below, and measurement of relative humidity, air temperature, and crop temperature as measured using thermocouples. The data generated are indicative of water use and photosynthesis as shown in FIG. 13.

At an ambient temperature above 88° F., potential photosynthesis decreases by 50%. CO₂ fixation begins to be inhibited above 77 to 86° F. and rapidly falls off at temperatures in the 90's. Thus one goal of the Example is to demonstrate the feasibility of reduction of leaf temperature by the treatment of the disclosure, with corresponding preservation of photosynthetic rates as would be observed at lower temperatures.

The method also measures high potential photosynthesis, which occurs when the temperature is below 88° F. and vapor pressure deficit is below 30 hPa. Above these two parameters, the air has strong drying power, the stomata are closed down to a minimum to restrict water loss by transpiration, open only enough to prevent overheating, with little CO₂ assimilation occurring. Furthermore, respiration is rapidly increasing as the temperature increases, thus the maximum net potential photosynthesis occurs below these two parameters and the growth potential can be visualized as shown in FIG. 13, in the shaded area between the upper and lower curves.

Seven crops were used to obtain data: Pecan, Apple, Walnut, Grape, Plum, Tomato and Peppers. Water use efficiency improvement correlates with a better quality and larger crop with less water use.

“Mask/Diffusion” refers to treatment with an organic liquid calcium having the formulation as shown in Table 16 below. This treatment is also referred to as “conventional formula” and was applied at 2% or 4% as indicated below for specific experiments and crops.

TABLE 16

| | | Batch Wt. | |
|---|---|---|---|
| Raw Materials | Wt. % | (Lbs) | Gal. |
| Potable Water | 31.567 | 5860.19 | 703.5 |
| Calcium Hypochlorite [65] | 0.014 | 2.60 | |
| 7581P100L OV + Dust | | | |
| (Black & Magenta) cartridge | | | |
| Lecithin (Ultralec P or Yelkinol P) | 2.850 | 529.08 | |
| Sodium Carbonate | 0.400 | 74.26 | |
| P100 (magenta) cartridge | | | |
| Imasco 11HX Calcium Carbonate | 61.500 | 11417.04 | |
| P100(magenta) cartridge | | | |
| Denatured Ethyl Alcohol | 2.560 | 475.25 | |
| Clove Oil | 0.166 | 30.82 | |
| Vanzan ® Xanthum Gum | 0.135 | 25.01 | |
| P100 (magenta) cartridge | | | |
| Vansil ® W-50 | 0.808 | 150.00 | |
| P100 (magenta) cartridge | | | |
| Total | 100.000 | 18564.30 | 1370.1 |

VANSIL® W-50 is a fine grind of wollastonite (calcium metaxilicate) (Vanderbilt Minerals, LLC, Norwalk, Conn., USA)

### VANZAN® is a Xanthum Gum (Vanderbilt Minerals, LLC, Norwalk, Conn., USA)

### Procedure for Mixing for Table 16:

1. Load well water in High Shear Mixer. Begin agitation.
2. In mixer, load Calcium Hypochlorite, mix to dissolve.
3. In mixer, load Lecithin (Ultralec P or Yelkinol P), mix to disperse. Mix 10 minutes.
4. In Mixer, load Sodium Carbonate, mix to dissolve. Mix 5 minutes.
5. In Mixer, load Imasco 11HX Calcium Carbonate while mixing.
6. In Mixer, load Denatured Ethyl Alcohol, mix to disperse.
7. In Mixer, load Clove Oil. Mix 10 minutes.
8. In shaker hopper, load Vanzan®, turn on shaker, sift into mixer to disperse. After sifting is complete, continue mixing 30 minutes.
9. In Mixer, load Vansil® W-50, mix to disperse. Continue to mix final batch 1 hour.
10. From Mixer, measure pH. The pH should be in the range 10.0-10.8.

Pecans.

Pecans have large leaves and these were grown without irrigation. A 2% conventional formula application was used. June morning temperatures when the experiment was performed were in the 70's, reaching the 90's before 10 a.m., which particularly accentuated the high potential photosynthesis as it was only in this range for a short time each day. The results were as follows for pecans:

10-15% less transpiration on average
5-10% less water
5-30% less time over 88° F.
5-40% more potential photosynthesis
50-75% more high potential photosynthesis

Apples.

The daytime temperatures were in the 70's and 80's. A 4% solution of Mask/Diffusion formulation was used, with one spray application. There was no irrigation. The results were as follows:

5-10% less transpiration on average
5-10% less water
5-30% less time over 88° F.
5-10% more potential photosynthesis
15-45% more high potential photosynthesis

Three additional crops were tested: irrigated grapes, irrigated walnut, and plum. The thermocouples were installed, the RH recorders were installed, and the crops were sprayed with a 2% Mask/Diffusion solution just prior to a major temperature increase to the upper 90's, with the daytime humidity dropping below 20%. The experiment was run for six weeks into late August.

The Results with Grapes were as Follows:

5-15% less transpiration on average
5% less water
20-40% less time over 88° F.
25-30% more potential photosynthesis
25-30% more high potential photosynthesis

Walnuts.

The mature walnuts leaves held the thermocouples securely for the six weeks. After six weeks with one application of 2% Mask/Diffusion solution, the trees had no evidence of sunburn, and the leaves were still covered with the treatment.

Results for Walnut were as Follows:

5-15% less transpiration on average
5-10% less water
15-30% less time over 88° F.
20-40% more potential photosynthesis
15-40% more high potential photosynthesis

Plum.

In the non-irrigated plum tree, the thermocouples remained the full time of the experiment, but they had to be installed at the leaf stem junction instead of in the leaf itself as they are smaller leaves. The results with plum were as follows:

10% less transpiration on average
5% less water
5-40% less time over 88° F.
15-55% more potential photosynthesis
25-30% more high potential photosynthesis

Peppers and tomatoes were tested during a phase of mostly clear, windy and 90 degree days. Plants were treated with a 2% solution. Data collection was performed and yielded the following results for tomatoes and peppers combined:

5% less transpiration on average
5% less water
10-30% less time over 88° F.
5-15% more potential photosynthesis
10-30% more high potential photosynthesis

In conclusion for Example 6, these proof-of-principle experiments with five tree species and two vegetable species provide evidence that treating plant leaves with a composition as described in Table 16 reduced leaf temperature and reduced water use. This information taken together with the full disclosure validates the use of the CaCO₃+TiO₂ treatments of the invention as a new method of slowing down strong light avoidance movement of chloroplasts while at the same time providing protection of the plant from the sun and heat. With such treatment, the plants can better retain their ability to capture CO₂ and continue photosynthesis.

### Example 7. Use of CaCo₃/TiO₂ Treatment to Reduce Winter Daytime Temperature in Walnut Tree Buds

This Example describes a test to measure CaCo₃/TiO₂ treatment (T) of Smith Walnut trees in comparison with untreated controls. The formulation shown in Table 4 (CCCDGFW-T) was used. Two aspects of chilling over the winter were investigated using thermocouples: (1) an overall reduction in the daytime temperature increase with a percent change of time below 60° F.; (2) a reduction in the time of high temperatures above 60° F. which increase respiration in the stems and buds using up valuable energy for bud differentiation and bud break.

The temperature data set was from February 12 to March 6. Six thermocouples were used: one for the air temperature, two for the control inserted into buds, and three for the treated inserted into buds (three each for tests designated T1, T2, and T3) recording every five minutes making about 6500 recordings each. The application rate was at 4 gallons to the acre. Most days the mid-day temperature increases in the treated trees were several degrees cooler than the untreated control.

To further investigate the treatment, a sunny period from February 14 to 21 was chosen for analysis. The mid-day temperature differences of the average control versus the treated T1, T2 and T3 were calculated. A 41% reduction in temperature was seen for the treated T1 compared to the daytime increases for the untreated control. T2 and T3 showed differences of 40% and 20% making a 34% average treated reduction.

In conclusion for this Example, application of a CaCo₃/TiO₂ formulation to walnut trees correlated with reducing the increased temperature that would otherwise be experienced by the buds during wintertime sunny days, thus enhancing the chilling effect of the winter temperature.

### Example 8. Use of CaCo₃/TiO₂ Treatment to Reduce Winter Daytime Temperature in Cherry Tree Buds

This Example describes a test to measure CaCo₃/TiO₂ treatment (T) of M&R Packing Cherry trees in comparison with untreated controls. The formulation shown in Table 4 (CCCDGFW-T) was used. As in Example 8, two aspects of chilling over the winter were investigated using thermocouples: (1) an overall reduction in the daytime temperature increase with a percent change of time below 60° F.; (2) a reduction in the time of high temperatures above 60° F. which increase respiration in the stems and buds using up valuable energy for bud differentiation and bud break.

The air temperature stayed generally below 60° F. for many of the mid-day highs. Over half the nights, the temperatures reached into the 30's and low 40's helping to increase the chilling hours. Generally, on cloudy days all the temperatures were comparable. On sunny days the control bud temperature rose above the air temperature by 5 to 10° F., and there were over half sunny days early. On clear nights there is radiant chilling which causes the buds to be colder than the air by a couple degrees; the CaCO₃/TiO₂ formulation of the disclosure did not hinder this in any way. Data was gathered from January 23 to March 3. There were early warmer days, although generally the temperature was still cool.

In conclusion, one field showed a 22% reduction in bud temperature for the treated T1 trees compared to untreated control in that field. In field two, from January 23 to February 14, the T1 trees showed a 56% reduction compared to control untreated, and T2 and T3 showed a 40% average reduction. Field three showed an average 30% reduction in temperature for the T2 and T3 trees compared to untreated control.

Based on these studies, a conclusion can be drawn that cherry trees treated with a CaCO₃/TiO₂ formulation of the disclosure showed a reduction in bud temperature compared to untreated controls in mid-day, when the sun was most intense on clear winter days. The results also show a measurable chill increase. The combination of reduced daytime bud temperature and chill increase can lead to an improvement in the carbohydrate status in the trees at bud break, particularly when early spring daytime temperatures increase.

### Example 9. Use of CaCo₃/TiO₂ Treatment to Reduce Winter Daytime Temperature in Pomegranate Tree Buds

This Example provides results of comparing treated to an untreated control pomegranate trees to evaluate the effect of a CaCO₃/TiO₂ formulation on chilling effectiveness. The formulation shown in Table 4 (CCCDGFW-T) was used. In a first study, the temperature data were collected from January 25 to February 5; even though it was only for two weeks and in cool weather, a 30% mid-day temperature improvement (reduction compared to the control) was recorded.

In a second data set, with slightly cooler temperatures though more sunny days, the data showed that the treatment improved chilling and lowered the mid-day bud temperatures. As in Examples 7 and 8, there are two aspects to chilling over the winter that are investigated using thermocouples: an overall reduction in the daytime temperature increase with a percent change of time below 60° F., and a reduction in the time of high temperatures above 60° F., which increases respiration in the stems and buds using up valuable energy for bud differentiation and bud break.

The second temperature data set was collected from February 5 to February 20. There were 6 thermocouples in each field, one for the air temperature and two for the control inserted into buds and three for the treated inserted into buds, recording temperatures every five minutes making about 4800 recordings each. Rates of application of the treatment were at 4 gallons to the acre.

The air temperature generally stayed below 65° F. for the mid-day highs and cooled more after February 14. The night temperatures were in the 30's and low 40's, helping to increase the chilling hours. Generally, on cloudy days the temperatures were similar. On sunny days the control bud temperature rose above the air temperature by 5 to 10° F. and there were mostly sunny days early in the data period. On clear nights there was radiant chilling which causes the buds to be colder than the air by a couple degrees

In conclusion, one field showed a 31% reduction in bud temperature for the treated T1 trees compared to untreated control in that field. The two other fields also showed reductions in bud temperature, with a 35% average reduction for the three fields (T1, T2 and T3) compared to untreated control.

Based on these studies, a conclusion can be drawn that pomegranate trees treated with a CaCO₃/TiO₂ formulation of the disclosure showed a reduction in bud temperature compared to untreated controls in mid-day, when the sun was most intense on clear winter days. The results also show a measurable chill increase. The combination of reduced daytime bud temperature and chill increase can lead to an improvement in the carbohydrate status in the trees at bud break, particularly when early spring daytime temperatures increase.

As will be understood by one of ordinary skill in the art, each embodiment disclosed herein can comprise, consist essentially of, or consist of its particular stated element, step, ingredient or component. Thus, the terms “include” or “including” should be interpreted to recite: “comprise, consist of, or consist essentially of.” The transition term “comprise” or “comprises” means includes and allows for the inclusion of unspecified elements, steps, ingredients, or components, even in major amounts. The transitional phrase “consisting of” excludes any element, step, ingredient or component not specified. The transition phrase “consisting essentially of” limits the scope of the embodiment to the specified elements, steps, ingredients or components and to those that do not materially affect the embodiment. A material effect would cause a statistically-significant reduction in a claimed composition or method's effectiveness in accomplishing the intended effect of the composition or method.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that can vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. When further clarity is required, the term “about” has the meaning reasonably ascribed to it by a person skilled in the art when used in conjunction with a stated numerical value or range, i.e. denoting somewhat more or somewhat less than the stated value or range, to within a range of ±20% of the stated value; ±19% of the stated value; ±18% of the stated value; ±17% of the stated value; ±16% of the stated value; ±15% of the stated value; ±14% of the stated value; ±13% of the stated value; ±12% of the stated value; ±11% of the stated value; ±10% of the stated value; ±9% of the stated value; ±8% of the stated value; ±7% of the stated value; ±6% of the stated value; ±5% of the stated value; ±4% of the stated value; ±3% of the stated value; ±2% of the stated value; or ±1% of the stated value. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a,” “an,” “the”, and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. It is anticipated that one or more members of a group can be included in, or deleted from, a group for reasons of convenience and/or patentability. When any such inclusion or deletion occurs, the specification is deemed to contain the group as modified thus fulfilling the written description of all Markush groups used in the appended claims.

Particular embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Furthermore, references have been made to patents, printed publications, journal articles and other written text throughout this specification (referenced materials herein). Each of the referenced materials is individually incorporated herein by reference in their entirety for their referenced teaching.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention can be embodied in practice.

Definitions and explanations used in the present disclosure are meant and intended to be controlling in any future construction unless clearly and unambiguously modified in the following examples or when application of the meaning renders any construction meaningless or essentially meaningless. In cases where the construction of the term would render it meaningless or essentially meaningless, the definition should be taken from Webster's Dictionary, 3rd Edition or a dictionary known to those of ordinary skill in the art, such as the Oxford Dictionary of Biochemistry and Molecular Biology (Ed. Anthony Smith, Oxford University Press, Oxford, 2004).

In closing, it is to be understood that the embodiments of the invention disclosed herein are illustrative of the principles of the present invention. Other modifications that can be employed are within the scope of the invention. Thus, by way of example alternative configurations of the present invention can be utilized in accordance with the teachings herein. Accordingly, the present invention is not limited to that precisely as shown and described.

The invention claimed is:

1. A method for reducing bud temperature increases during dormancy of a deciduous plant, said method comprising treating said plant with a composition comprising nanoparticles of titanium dioxide, nanoparticles of calcium carbonate, at least one surfactant, and water in an amount adequate to provide flowability.

2. The method of claim 1 wherein said treatment is formulated with wet ground calcium carbonate and comprises components selected from the following ranges: Potable water, 8.85-20.85 w/w %; Esperse 366, 0.5-1 w/w %; Titanium dioxide, 0.5-5.0 w/w %; CCCWG at 74% Calcium Carbonate, 78-84 w/w %; Silicone PMX200, 0.1-0.5 w/w %; Mergal K10N, 0-0.25 w/w %; Mergal 186, 0-0.25 w/w %; and Guar Gum, 0.05-0.15 w/w %.

3. The method of claim 1 wherein said plant is selected from the group consisting of but not limited to almond, apricot, cherry, grape, pear, peach, nectarine, pistachio, plum, walnut, apple, blackberry, blueberry, chestnut, currant, fig, filbert, gooseberry, kiwi, mulberry, persimmon, plum cot, pomegranate, quince, strawberry, and raspberry.

4. The method of claim 1 wherein said treatment covers at least 40%, at least 50%, or at least 60% of said plant trunk, stem, branch and bud area.

5. The method of claim 1 wherein said treatment is applied at least once prior to endodormancy.

6. The method of claim 1 wherein said treatment is applied at least once after endodormancy and prior to bud break.

7. The method of claim 6 wherein said treatment is applied two, three, or four times after endodormancy and prior to bud break.

8. A method of increasing winter chill accumulation in a deciduous plant, said method comprising treating said plant with a composition comprising nanoparticles of titanium dioxide, nanoparticles of calcium carbonate, at least one surfactant, and water in an amount adequate to provide flowability.

9. The method of claim 8 wherein said treatment is formulated with wet ground calcium carbonate and comprises components selected from the following ranges: Potable water, 8.85-20.85 w/w %; Esperse 366, 0.5-1 w/w %; Titanium dioxide, 0.5-5.0 w/w %; CCCWG at 74% Calcium Carbonate, 78-84 w/w %; Silicone PMX200, 0.1-0.5 w/w %; Mergal K10N, 0-0.25 w/w %; Mergal 186, 0-0.25 w/w %; and Guar Gum, 0.05-0.15 w/w %.

10. The method of claim 8 wherein said plant is selected from the group consisting of but not limited to almond, apricot, cherry, grape, pear, peach, nectarine, pistachio, plum, walnut, apple, blackberry, blueberry, chestnut, currant, fig, filbert, gooseberry, kiwi, mulberry, persimmon, plum cot, pomegranate, quince, strawberry, and raspberry.

11. The method of claim 8 wherein said treatment covers at least 40%, at least 50%, or at least 60% of said plant trunk, stem, branch and bud area.

12. The method of claim 8 wherein said treatment is applied at least once prior to endodormancy.

13. The method of claim 8 wherein said treatment is applied at least once after endodormancy and prior to bud break.

14. The method of claim 13 wherein said treatment is applied two, three, or four times after endodormancy and prior to bud break.
